(19) United States
(12) Patent Application Publication
(10) Pub. No.: US 2026/0312483 A1
(43) Pub. Date: Oct. 8, 2026

(54) POWER CONVERTER CONTROL WITH SECOND ORDER HARMONIC INJECTION

(71) Applicant: The Trustees of Columbia University in the City of New York, New York, NY (US)

(72) Inventors: Liwei Zhou, New York, NY (US); Noah Silverman, New York, NY (US); Matthias Preindl, New York, NY (US)

(21) Appl. No.: 19/476,438

(22) PCT Filed: Apr. 19, 2024
(86) PCT No.: PCT/US2024/025399

§ 371 Date: Oct. 17, 2025

Related U.S. Application Data
(60) Provisional application No. 63/461,167, filed on Apr. 21, 2023.

(51) Int. Cl. H02M 1/12; B60L 53/24; H02M 1/088; H02M 7/539

(52) U.S. Cl. CPC H02M 1/12; B60L 53/24; H02M 1/088; H02M 7/539; B60L 2210/30; B60L 2210/40

(57) ABSTRACT

Power conversion systems and methods are provided that use a second order harmonic injection for a power converter. The power converter includes a direct current (DC) voltage section including the DC bus, an alternating current (AC) voltage section including AC connection nodes, and power switching elements. A control system for controlling the power converter determines rotational reference frame targets including a zero-sequence component target that is based on a DC bus voltage on the DC bus and a second order harmonic injection. The control system generates control reference targets in a stationary reference frame based on the rotational reference frame targets and drives the power switching elements in accordance with the control reference targets. The second order harmonic injection can cause storage of energy in a common mode of the power converter and reduce a second order pulse on a DC bus of the power converter.

### CROSS-REFERENCE TO RELATED APPLICATIONS

This application claims priority to U.S. Provisional Application No. 63/461,167, filed on Apr. 21, 2023, titled “Power Converter Control with Second Order Harmonic Injection,” which is hereby incorporated by reference in its entirety.

### STATEMENT REGARDING FEDERALLY SPONSORED RESEARCH

N/A

### BACKGROUND

Power converters of various types have been produced and used in many industries and contexts. Example power converters include alternating current (AC) to direct current (DC) rectifiers, DC to AC inverters, and DC to DC converters. AC to DC rectifiers, also referred to as AC/DC rectifiers, convert AC power to DC power. DC to AC inverters, also referred to as DC/AC inverters, convert DC power to AC power. Power converters can be used for various purposes, such as rectifying AC power from an AC grid power source to DC power for charging a battery, or inverting DC power from a battery to AC power to drive a motor or supply AC power to an AC grid. Further, power converters can be used in various contexts, such as in or connected to an electric vehicle, an engine generator, solar panels, and the like.

### SUMMARY

Some embodiments described herein provide for power conversion systems and methods that use a second harmonic injection (SHI). Use of the second harmonic injection can provide power conversion with reduced second order pulsation, stored energy in a common mode of the power converter, improved dynamic performance and control bandwidth, lower total harmonic distortion (THD), lower leakage current, reduced capacitor size and costs (e.g., of a capacitor(s) on a DC bus of the power converter), and/or elimination of additional passive or active components that may otherwise be used. In some examples, effectively, the second order harmonic balances the power converter system, leverages the common mode for energy storage, and can allow a third harmonic oscillation. In some examples, the power conversion systems and methods further use model predictive control (MPC) in combination with SHI to provide a model predictive control-based second harmonic injection (MPC-SHI) control technique for power conversion.

In one embodiment, a power converter system is provided. The system includes a power converter with a direct current (DC) voltage section including a DC bus and an alternating current (AC) voltage section including AC connection nodes, the power converter including power switching elements. The power converter further includes a control system configured to control the power converter. The control system is configured to determine rotational reference frame targets, the rotational reference frame targets including a zero-sequence component target, wherein the zero-sequence component target is based on a DC bus voltage on the DC bus and a second order harmonic injection, wherein the second order harmonic injection is determined based on a second order harmonic of a frequency of an AC signal of the AC voltage section. The control system is further configured to: generate control reference targets in a stationary reference frame based on the rotational reference frame targets; generate control signals for the power switching elements based on the control reference targets; and drive the power switching elements in accordance with the control signals.

In one embodiment, a method of power converting is provided. The method includes determining rotational reference frame targets for a power converter including a direct current (DC) voltage section including a DC bus, an alternating current (AC) voltage section including AC connection nodes, and power switching elements, the rotational reference frame targets including a zero-sequence component target, wherein the zero-sequence component target is determined based on a DC bus voltage on the DC bus and a second order harmonic injection, wherein the second order harmonic injection is based on a second order harmonic of a frequency of an AC signal of the AC voltage section. The method further includes generating control reference targets in a stationary reference frame based on the rotational reference frame targets. The method further includes driving the power switching elements of the power converter in accordance with the control reference targets.

In one embodiment, a power converter system is provided. The system includes a three-phase power converter with a direct current (DC) voltage section including a DC bus and an alternating current (AC) voltage section including AC connection nodes, the power converter including four phase legs including a first phase leg, a second phase leg, a third phase leg, and a neutral phase leg, each of the first, second and third phase legs having a respective LC filter and respective power switching elements, and the neutral phase leg having neutral leg power switching elements and a neutral leg LC filter. The system further includes a control system configured to control the power converter. The control system is configured to: determine rotational reference frame targets, the rotational reference frame targets including a zero-sequence component target, wherein the zero-sequence component target is based on a DC bus voltage on the DC bus and a third order harmonic injection, wherein the third order harmonic injection is determined based on a third order harmonic of a frequency of an AC signal of the AC voltage section. The control system is further configured to: determine a neutral leg reference target based on a ratio of neutral voltage and DC bus voltage; generate control signals for the power switching elements based on the control reference targets; drive the power switching elements in accordance with the control signals; and drive the neutral leg power switching elements in accordance with the neutral leg reference target.

In one embodiment, a method of power converting is provided. The method includes determining rotational reference frame targets for a three-phase power converter including a direct current (DC) voltage section including a DC bus, an alternating current (AC) voltage section including AC connection nodes, and power switching elements for each of three phases of the power converter, the rotational reference frame targets including a zero-sequence component target, wherein the zero-sequence component target is determined based on a DC bus voltage on the DC bus and a third order harmonic injection, wherein the third order harmonic injection is based on a third order harmonic of a frequency of an AC signal of the AC voltage section. The method further includes determining a neutral leg reference target for a neutral phase leg based on a ratio of neutral voltage and DC bus voltage, the neutral phase leg including neutral leg power switching elements and a neutral leg LC filter. The method further includes generating control reference targets in a stationary reference frame based on the rotational reference frame targets. The method further includes driving the power switching elements of the power converter in accordance with the control reference targets. The method further includes driving the neutral leg power switching elements in accordance with the neutral leg reference target.

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

FIG. 1 illustrates a power converter system according to some embodiments.

FIG. 2 illustrates a single-phase grid-connected inverter system according to some embodiments.

FIG. 3 illustrates DC side voltage/current fluctuations at twice a grid line frequency.

FIG. 4 illustrates a single-phase power converter according to some embodiments.

FIG. 5 illustrates a control system for a single-phase power converter according to some embodiments.

FIGS. 6A-6B illustrate a single-phase power converter system according to some embodiments.

FIGS. 7 and 8 provide additional illustrations of an operating mechanism of injected second harmonics according to some embodiments.

FIG. 9 illustrates a control plant model for a single-phase power converter according to some embodiments.

FIG. 10 illustrates bode plots of DC bus voltage tracking error and grid current measurement.

FIGS. 11A-11B and 12A-12B illustrate steady state performance plots of electrical characteristics for model predictive control with secondary harmonic injection (MPC-SHI) controlled power converters according to some embodiments.

FIG. 13 illustrates transient performance for a conventional PI-based second harmonic injection technique.

FIGS. 14-15 illustrate transient performance plots of electrical characteristics for model predictive control with secondary harmonic injection (MPC-SHI) controlled power converters according to some embodiments.

FIGS. 16A-16B illustrate a comparison between a conventional PI-based control technique and an MPC-SHI control technique according to some embodiments.

FIGS. 17, 18A-18B, and 19A-19B illustrate a comparison between transient performance of a conventional PI-based control technique and an MPC-SHI control technique according to some embodiments.

FIG. 20 illustrates total harmonic distortion and leakage current in a power converter controlled with an MPC-SHI control technique according to some embodiments.

FIG. 21 illustrates a process for converting voltage using harmonic injection, according to some embodiments.

FIG. 22 illustrates a functional block diagram for performing a conversion from a stationary reference frame to a rotational reference frame and for determining a reference phase θ* according to some embodiments.

FIG. 23 illustrates a split-phase power converter according to some embodiments.

FIG. 24 illustrates a control system for a split-phase power converter according to some embodiments.

FIG. 25 illustrates a three-phase power converter according to some embodiments.

FIG. 26 illustrates a control system for a three-phase power converter according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “comprising,” “including,” “containing,” “having,” and variations thereof herein is meant to encompass the items listed thereafter and equivalents thereof as well as additional items. Additionally, the terms “connected” and “coupled” are used broadly and encompass both direct and indirect connecting and coupling, and may refer to physical or electrical connections or couplings. Furthermore, the phase “and/or” used with two or more items is intended to refer to these items individually and together. For example, “a and/or b” is intended to mean: a (and not b); b (and not a); and a and b.

Single-phase grid-connected inverters are used in renewable energy conversion systems and micro-grid systems. For example, solar energy, battery storage systems and other DC energy resources can use the single-phase inverters to deliver low power energy conversion to be connected with the AC grid. With the development of clean energy and the target of net-zero emission, micro-inverters are attracting more research focus since the inverter-based distributed energy resources are components of a micro-grid renewable system. A single-phase inverter is a type of micro-inverter for such an energy conversion system. The performance of single-phase inverters may, accordingly, influence the popularization of distributed renewable energy resources. Issues of single-phase inverters to be improved relate to second order pulsation, control dynamic performance, and leakage current.

Second order pulsation refers to a second order pulsation found on the DC side or DC bus of a power converter (e.g., a single-phase inverter). The second order AC pulsation on the DC side can result from unbalanced AC and DC power on the power converter. Such second order pulsations can appear on the DC bus voltage or current depending on the type of DC source, and can result in issues such as output side distortion, saturation, and unstable performance in power converters. In some single-phase inverters, this pulsation may be stored and released through the DC source(s), or a large DC capacitor may be used to damp the unbalanced power by charging and discharging the AC pulsation. Several techniques have been studied to attenuate this second order pulsation including passive and active power decoupling methods. For the passive method, magnetic components of inductors and capacitors are leveraged for the DC side second pulsation reduction. For example, either split DC capacitors or LC circuits can be inserted between the DC and AC for the power decoupling. For the active method, extra switches form auxiliary circuits for the second pulsation attenuation. Traditional power decoupling control methods include applying a proportional integral (PI), proportional resonant (PR), or notch filter to deal with the second order pulsation. These control methods damp the specific even order harmonics by sacrificing the control bandwidth, hindering dynamic performance of the power converter.

For the control dynamic performance of a single-phase inverter, a PI controller may be used. However, if the control is implemented in the dq synchronous reference frame, the second pulsation may be reflected in the dq components. Thus, the output power quality can be deteriorated. An extra notch filter or band-pass filters can be added to address the specific order harmonics. However, these filters can worsen the control performance with limited bandwidth.

Some embodiments described herein address these and/or other issues. For example, some embodiments described herein provide for power conversion systems and methods that use a second harmonic injection (SHI). Use of the second harmonic injection can provide power conversion with reduced second order pulsation, stored energy in a common mode of the power converter, improved dynamic performance and control bandwidth, lower total harmonic distortion (THD), attenuated output side current distortion, lower leakage current, reduced capacitor size and costs (e.g., of a capacitor(s) on a DC bus of the power converter), stabilized voltage and current on the DC bus, and/or elimination of additional passive or active components that may otherwise be used. In some examples, the power conversion systems and methods further use model predictive control (MPC) in combination with SHI, to provide a model predictive control-based second harmonic injection (MPC-SHI) control technique for power conversion.

The MPC-SHI control technique can attenuate the DC side second pulsation for the single-phase inverter. The directly calculated SHI component can be configured as a tracking reference and regulated by the MPC with improved dynamic performance. The combination of MPC and SHI enhances the transient behavior with less response time and oscillation. In some examples, compared with other control methods, the MPC-SHI control techniques can one or more of the following: include no extra notch filter or band-pass filters to address second order harmonics in the control process; increase the control bandwidth with more tuning flexibility and better dynamic performance; and include no extra passive or active components to attenuate the DC side second pulsation (e.g., large DC capacitors), which reduces costs and complexity.

The SHI and MPC-SHI control techniques can be used in power converters of various types (e.g., single-phase, split-phase, or software-configurable multi-phase power converters configured for single-phase or split-phase operation) and converting operations of various types. For example, these control techniques can be used to control a power converter to convert AC power to DC power (grid following operation) to provide a DC source, as well as to invert DC power to AC power (grid forming operation). In some examples, the power converter is incorporated into an electric vehicle to provide one or more of charging of a vehicle DC battery (e.g., via AC/DC conversion using AC grid as power source) or AC power supply (e.g., via DC/AC conversion using vehicle DC battery as DC power source) to an existing AC grid, an AC grid formed by the AC power supply, or an AC traction motor.

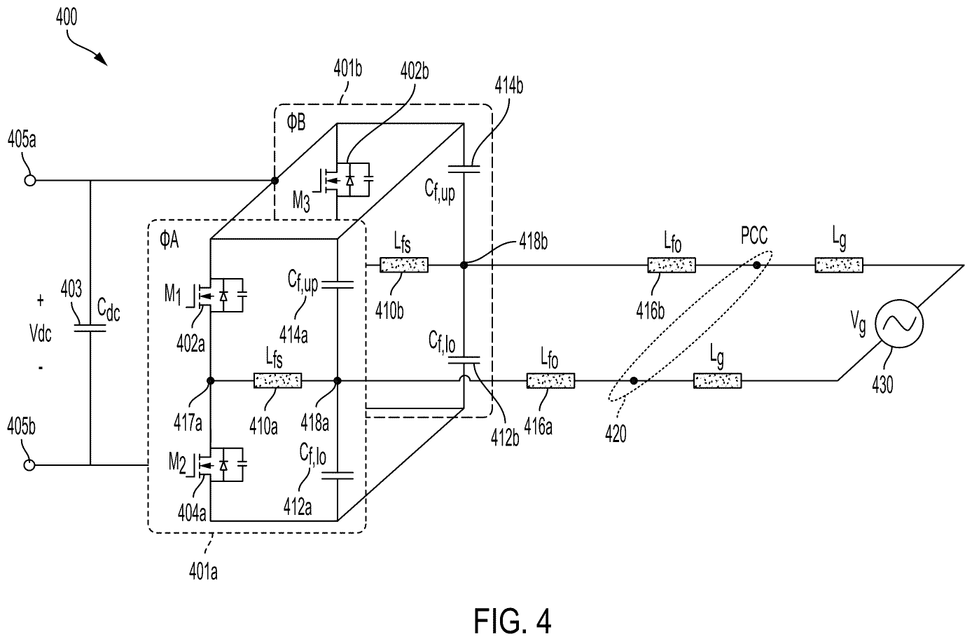

Additionally, in power converter systems that can be controlled to operate as a three-phase converter in some instances and as a single-phase or split-phase converter in other instances (e.g., some of the power converter systems described herein), techniques described herein to mitigate second order pulsation may render the power converter system more adaptable to switch between operation modes. For example, a size of a DC-link capacitance (see, e.g., capacitor 403 of FIG. 4) desired for single-phase operation may more closely match a size of the DC-link capacitance desired for three-phase operation. With the mitigation techniques described herein, the power converter system may avoid large or oversized DC-link capacitance that may otherwise be included for single-phase due to the second order pulsation. Thus, the power converter may be a universal grid-tied converter for different modes and grid types with a reduced size, cost, and/or power density, because of the reduced DC-link capacitance.

Accordingly, disclosed herein are systems and methods related to power converters, also referred to as voltage converters, that can provide power conversion using second harmonic injection.

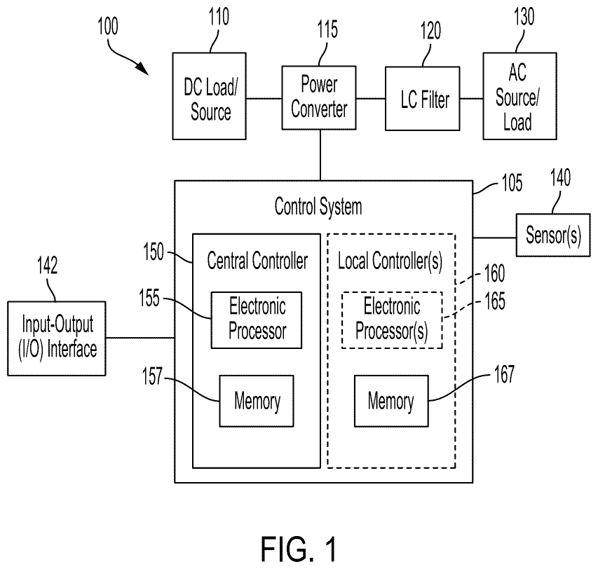

FIG. 1 illustrates a power converter system 100 in accordance with some embodiments. The power converter system 100 includes a control system 105, a first direct current (DC) load/source 110, a power converter 115, an LC filter 120, an AC source/load 130, and one or more sensors 140. The control system 105 includes a central controller 150 with an electronic processor 155 and a memory 157, and, optionally, in some embodiments, includes one or more local controllers 160, each having an electronic processor 165 and a memory 167. The power converter system 100, as well as the other power converter systems provided herein, may be non-isolated power converter systems. That is, the power converter system may be coupled to an AC source (e.g., single or three phase power grid) or AC load (e.g., single or 3-phase motor) without a transformer. Use of a transformer is common in electrical circuits to provide isolation between the power converter and an AC source or load. However, such a transformer can add inefficiencies and size or volume to the power converter. Accordingly, in at least some examples, power converter systems provided herein are non-isolated, also referred to as transformerless, to increase efficiency and/or reduce size of the power converter systems. Because the power converters are provided without isolation by a transformer, the power converters may include additional features to prevent transmission of unwanted signals or current (e.g., leakage current) from passing between the power converters and other circuit components (e.g., DC sources, DC loads, AC sources, AC loads, and other structures in contact with or supporting the power converters). These additional features may include LC filters, zero-sequence control of common mode voltage, harmonic injection, model predictive control, and the like described herein. In other examples, the power converter system 100 is isolated and, for example, includes a transformer to connect the power converter system 100 to a load or source. For example, a transformer may be provided to connect the LC filter 120 to the AC source/load 130.

In operation, generally, the control system 105 controls power switching elements of the power converter 115 with control signaling (e.g., pulse-width modulated (PWM) signals) to convert power (i) from the DC load/source 110 functioning as a source to the AC source/load 130 functioning as a load, or (ii) from the AC source/load 130 functioning as a source to the DC load/source 110 functioning as a load. Accordingly, when the DC load/source 110 is functioning as a source for the power converter 115, the AC source/load 130 is functioning as a load for the power converter 115. Conversely, when the DC load/source 110 is functioning as a load for the power converter 115, the AC source/load 130 is functioning as a source for the power converter 115.

The DC load/source 110 may be a direct power (DC) load, a DC source, or both a DC load and DC source (i.e., functioning as DC source in some instances and as a DC load in other instances, depending on the mode of the power converter 115). In some examples, the DC load/source 110 is a battery including one or more battery cells (e.g., an electric vehicle battery or backup power battery). In other examples, DC load/source 110 may be a capacitor, an ultracapacitor, a DC power supply from rectified AC source (e.g., AC grid power converted to DC power by diode bridge rectifier), or the like. The AC source/load 130 may be an AC load, an AC source, both an AC load and AC source (i.e., functioning as an AC source in some instances and as an AC load in other instances, depending on the mode of the power converter 115). In some examples, the AC source/load 130 may be an electric (AC) motor, an AC generator, AC power supply grid, or the like.

The DC load/source 110 is coupled to the power converter 115 at a first (DC) side or section of the power converter 115, and the AC source/load 130 is coupled to the power converter 115 at a second (AC) side or section of the power converter 115. The first side may also be referred to as an input side or an output side of the power converter 115, depending on the mode of the power converter, or as a DC side of the power converter 115. The second side may also be referred to as an input side or an output side of the power converter, depending on the mode of the power converter, or as an AC side of the power converter 115. In some embodiments, the second side of the power converter 115 may be an AC side having single-phase AC power, three-phase AC power, or AC power with another number of phases.

In some embodiments, the power converter 115 operates with a high DC voltage level. For example, in operation, the DC side of the power converter 115 has a DC voltage (e.g., across input terminals of the power converter 115) of at least 200 V, at least 600 V, at least 800 V, at least 1000 V, at least 1200 V, between 200 V and 1200 V, between 600 V and 1200 V, between 800 V and 1200 V, or another range. Such high DC voltage levels may be desirable in some contexts, such as some electric vehicles. For example, some current electric vehicles (e.g., passenger vehicles and hybrid electric vehicles) operate with a DC bus voltage of between about 200 V and 400 V. This DC bus voltage for passenger electric vehicle may increase in the future. Further, some current electric vehicles (e.g., class 4-8, off-road, or otherwise larger electric vehicles) can operate with a DC bus voltage of more than 1000 V. However, high DC voltage levels may introduce challenges into a typical power converter system, such as an increase in leakage currents, increases in common mode voltage, higher rates of change in common mode voltage, and the like. These challenges can lead to resonance on the LC filter 120, shaft voltages, excessive bearing currents (e.g., from discharge events when lubricant dielectric breakdown occurs) that can result in bearing failures, excessive motor shaft currents, excessive motor winding currents (e.g., insulation may be damaged), and excessive gear train currents (e.g., bearing currents can propagate into the gear train via electromagnetic interference (EMI) or noise, vibration, harshness (NVH) resulting from the damaged bearing race walls). Embodiments described herein, however, can mitigate such challenges through improved LC filters and through control techniques including control techniques that use harmonic injection, cascaded controllers, MPC control, and/or variable frequency critical soft switching (VFCSS).

The LC filter 120 may include an LC filter for each phase and/or each phase leg of the power converter 115. Each LC filter may include at least an inductor and a capacitor, or at least an inductor and two capacitors, as illustrated in further detail in FIGS. 4, 6, and 8 (see, e.g., a switch-side filter inductor L_{fs}, upper capacitor c_{f,up}, and lower capacitor c_{f,lo}, for each phase leg ΦA and ΦB).

The sensor(s) 140 include, for example, one or more current sensors and/or one or more a voltage sensors. For example, the sensor(s) 140 may include a respective current sensor and/or voltage sensor to monitor a current and/or voltage of one or more of the DC load source 110, each phase or phase leg of the AC source/load 130, each phase of the LC filter 120, or other nodes or components of the power converter 115. For example, when the LC filter 120 is a three-phase LC filter, the sensors 140 may include at least three current sensors, one for sensing current at each phase of a three phase LC filter 120. In some embodiments, additional or fewer sensors 140 are included in the system 100. For example, the sensors 140 may also include one or more vibration sensors, temperature sensors, and the like. In some examples, the control system 105 infers a characteristic (e.g., current or voltage) of the power converter 115, rather than directly sensing the characteristic. The sensor(s) 140 may provide sensor data to the control system 105 indicative of the sensed characteristics of the system 100. Such sensor data may, accordingly, indicate electrical operational characteristics of the system 100. In some examples, the control system 105 infers or estimates a characteristic (e.g., current or voltage) at one or more nodes of the power converter 115 based on the sensor data of a sensor 140 that senses a different type of characteristic or even a different component, rather than directly sensing the characteristic.

The input-output (I/O) interface 142 includes or is configured to receive input from one or more inputs (e.g., one or more buttons, switches, touch screen, keyboard, and the like), and/or includes or is configured to provide output to one or more outputs (e.g., LEDs, display screen, speakers, tactile generator, and the like). Other electronic devices and/or users may communicate with the system 100 and, in particular, the control system 105, via the I/O interface 142. For example, the control system 105 may receive commands (e.g., from a user or another device) for the power converter system 100 indicating a target torque, target speed, target power level, conversion type, or the like. The control system 105, in response, may drive the power converter 115 to achieve the target and/or conversion type indicated by the command. For example, in some examples, the control system 105 may convert the commands to a DC bus reference voltage (Vdc*) and a reactive power reference (Q*) that the control system 105 then uses as reference targets for controlling the power converter 115.

The control system 105 generally monitors the system 100 including the power converter 115 (e.g., based on sensor data from the sensor(s) 140), receives commands (e.g., via the input/output interface 142), and controls the power switching elements of the power converter 115 with control signaling (e.g., pulse-width modulated (PWM) signals) to convert power (e.g., in accordance with the sensor data and/or the commands). In some embodiments, the control system 105 includes a controller (e.g., the central controller 150) that performs this monitoring and control without additional local controllers. In other embodiments, the control system 105 is a cascaded control system including a central controller 150 and one or more local controllers 160. The cascaded control system may communicate in real time (e.g., each control cycle) monitoring information (e.g., sensor data) and control information between the central controller 150 and the one or more local controller 160. In some examples, the local controller(s) 160 each implement model predictive control (MPC) or another regulation control scheme (e.g., PID control, PI control, or the like). In some examples, the central controller implements a non-MPC regulation technique, such as proportional integral derivative (PID) control or proportional integral (PI) control.

Each controller of the control system 105, including the central controller 150 and the local controllers 160, is an electronic controller that may include an electronic processor. Such an electronic controller may further include a memory (e.g., the memory 157 or 167). The memory is, for example, one or more of a read only memory (ROM), random access memory (RAM), or other non-transitory computer-readable media. The electronic processor 155, 165 is configured to, among other things, receive instructions and data from the memory 157, 167 and execute the instructions to, for example, carry out the functionality of the associated controller described herein, including the processes described herein. For example, the memory may include control software. In some embodiments, instead of or in addition to executing software from the memory to carry out the functionality of the controller described herein, the electronic processor includes one or more hardware circuit elements configured to perform some or all of this functionality. For example, the electronic processor 155, 166 may be or include an application specific integrated circuit (ASIC) or field programmable gate array (FPGA). Additionally, although a particular controller, electronic processor, and memory may be referred to as a respective, single unit herein, in some embodiments, one or more of these components is a distributed component. For example, in some embodiments, an electronic processor includes one or more microprocessors and/or hardware circuit elements. The electronic processor(s) as described herein, including the electronic processors 155, 166, may also be referred to as processing unit(s).

### Second Order Pulsation

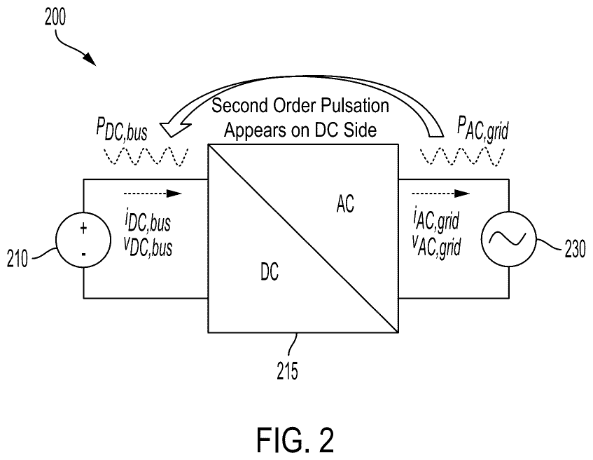

FIG. 2 illustrates a single-phase grid-connected inverter system 200. The system 200 is an example of the power system 100, with the control system 105, sensors 140, and I/O interface 142 not shown. The system 200 includes a DC source 210, a single-phase inverter 215, and an AC grid 230. DC source 210 is an example of the DC load/source 110, the single-phase inverter 215 is an example of the power converter 115 and LC filter 120 (in combination), and the AC grid 230 is an example of the AC source/load 130.

In a single-phase grid-connected inverter system, such as, for example, the system 200 shown in FIG. 2, an AC side output power, P_{AC,grid}, can be expressed as:

$$\begin{matrix}{P}_{AC , grid} = {v}_{AC , grid} ( t ) {i}_{AC , grid} ( t ) \\ = {V}_{AC , grid} sin ( ω t ) {I}_{AC , grid} sin ( ω t ) \\ = {V}_{AC , grid} {I}_{AC , grid} \frac{1 - cos ( 2 ω t )}{2}\end{matrix} , \qquad ( 1 )$$

where, v_{AC,grid}(t), i_{AC,grid}(t), v_{AC,grid} and I_{AC,grid} are instantaneous values and amplitudes of the AC grid side output voltage and current, respectively.

However, a DC side power, P_{DC,bus}, can be demonstrated as:

$${P}_{DC , bus} = {v}_{DC , bus} ( t ) {i}_{DC , bus} ( t ) , \qquad ( 2 )$$

where, v_{DC,bus}(t) and i_{DC,bus}(t) are instantaneous values of DC side voltage and current, respectively. If the energy conversion efficiency is η, the relationship between the output and input power can be expressed as:

$${P}_{AC , grid} = η {P}_{DC , bus} . \qquad ( 3 )$$

Then, the input DC side current can be further derived as:

$${i}_{DC , bus} ( t ) = η {V}_{AC , grid} {I}_{AC , grid} \frac{1 - cos ( 2 ω t )}{2 {v}_{DC , bus} ( t )} \qquad ( 4 )$$

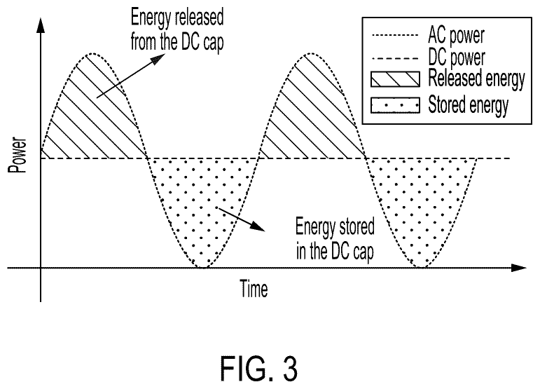

Thus, either the DC side is connected to a constant voltage source or configured as a floating DC bus to be cascaded with other energy conversion stages, and the DC side voltage/current fluctuates at twice of the grid line frequency because the DC side capacitor will store and release the AC component of the unbalanced energy as shown in FIG. 3. The peak-to-peak value of this second order pulsating waveform is determined by the current value and power level that are implemented on the inverter. This second order pulsation can be harmful to the operation of the single-phase inverter, especially when the DC bus capacitor is not large enough to damp the charge and discharge of the unbalanced power between the DC and AC sides. Severe issues, such as the output side current distortion, saturation and unstable conditions, may occur with power failure. Other attempts to remedy these issues can be classified into passive and active methods. Passive methods apply additional capacitors or inductors to damp the second pulsation, which can be large and costly. Active methods can include an auxiliary switch circuit that is actively controlled to attenuate the pulsation, which can result in a complex control scheme. Passive and active methods may further be combined with notch filter, band-pass filters, or PR controllers to deal with the even order harmonics, which can sacrifice the control performance and bandwidth. Also, extra switching and magnetic circuits result in more cost and complexity and introduce operation reliability concerns.

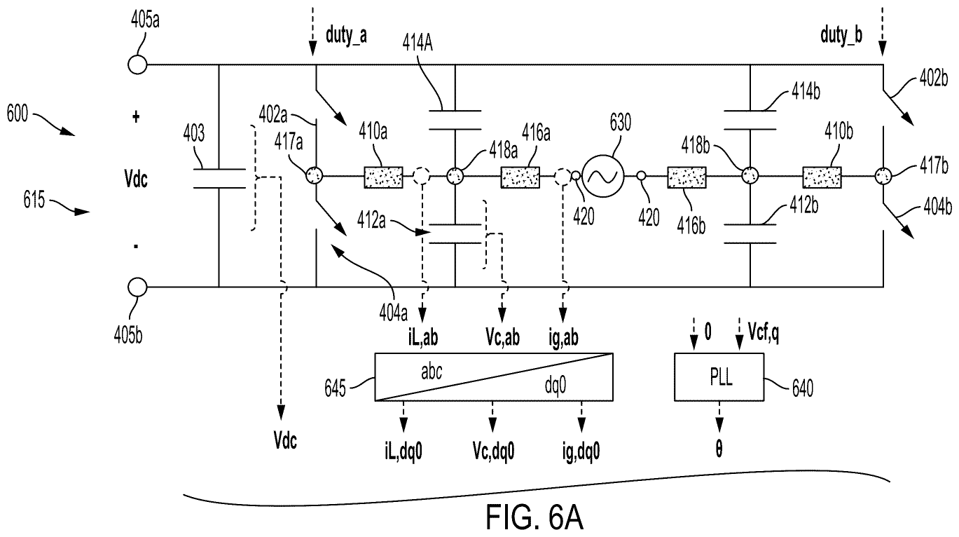

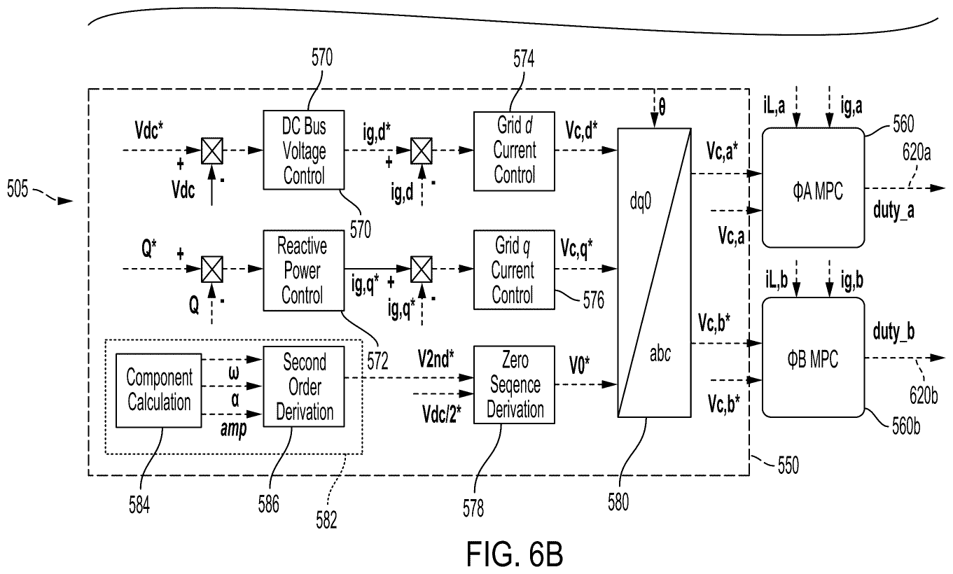

FIG. 4 illustrates a power converter 400 according to some examples. The power converter 400 is an example of the power converter 115 and LC filter 120 (in combination) of FIG. 1 and of the power converter 215 of FIG. 2. The power converter 400 is coupled to an AC grid 430, which is an example of the AC source/load 130 (FIG. 1) and of the AC grid 230 (of FIG. 2). The power converter 400 is a full bridge single-phase converter and may be controlled by the control system 105 (see FIG. 1) implementing second harmonic injection, as described herein. The single-phase power converter includes a first phase leg (ΦA) 401a and a second phase leg (ΦB) 401b, which are out of phase with one another by 180 degrees. The phase legs are coupled to a DC bus having a DC bus voltage (v_{dc}) across a positive DC node 405a and a negative DC node 405b (collectively, DC nodes), as well as across a DC side capacitor 403 (C_{dc}). Each phase leg includes a pair a power switching elements (also referred to as switches) and a filter. More particularly, the phase leg ΦA includes power switching elements 402a, 404a (M1, M2) and a filter including inductor 410a (Lfs), lower capacitor 412a (C_{f,lo}), and upper capacitor 414b (C_{f,up}). The phase leg ΦB includes a similar layout with a pair of power switching elements M3 and M4, with switch M3 labeled 402b and switch M4 being obscured by phase leg ΦA (but see switch M4 labeled 404b in FIGS. 6A-6B), and a filter including inductor 410b (L_{fs}), lower capacitor 412b (C_{f,lo}), and upper capacitor 414b (C_{f,up}). In some examples, the filter of each phase leg is coupled by a further inductor 416a, 416b to point of common coupling (PCC) nodes 420 (also referred to as AC connection nodes), which connects the converter to the AC grid 430. The switches M1, M2, M3, M4 may be implemented as field effect transistors (FETs), such as, for example, metal oxide semiconductor (MOS) FETs, gallium nitride (GaN) FETs, or silicon carbide (SiC) FETs, or the like.

The phase leg ΦA includes a first midpoint node 417a connecting the pair of switches 402a, 404a and a first filter node 418a connecting the capacitors 412a, 414a and the inductors 410a, 416a. The phase leg ΦB includes a second midpoint node 417b (see FIGS. 6A-6B) connecting the pair of switches 402b, 404b and a second filter node 418b connecting the capacitors 412b, 414b and the inductors 410b, 416b.

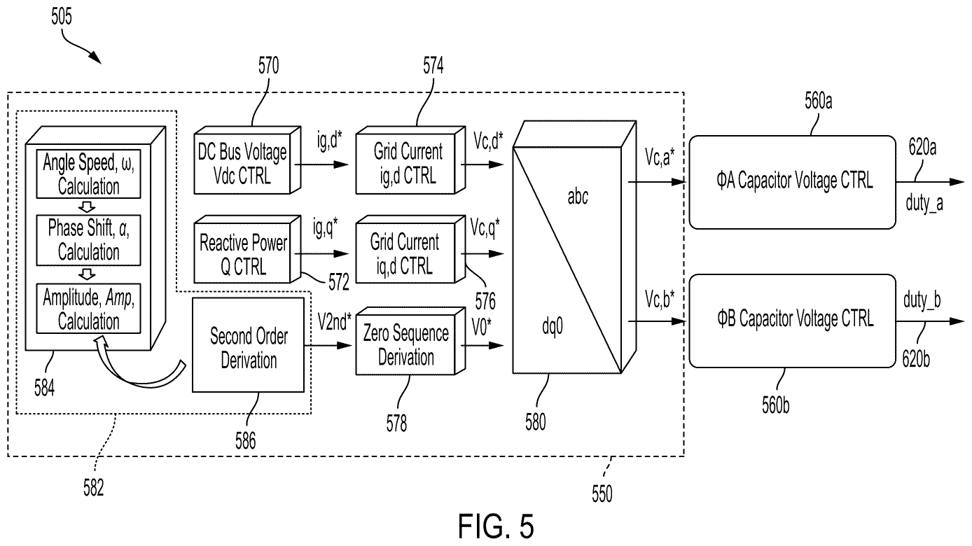

FIG. 5 illustrates a control system 505, which is an example of the control system 105, that may be used to control the power converter 400 to implement the second harmonic injection, as described herein. In the illustrated example, the control system 505 includes a central controller 550, which is an example of the central controller 150, and local controllers 560a and 560b, which are examples of the local controllers 160. In some examples, a single controller e.g., (the central controller 150) executes the control structure or functions illustrated in FIG. 5. FIGS. 6A-6B illustrate a power converter system 600 split across the two figures, where the power converter system 600 includes the control system 505 and a power converter 615. The power converter 615 includes a single-phase converter, such as, e.g., the power converter 400, and is another example of the power converter 115 and LC filter 120 (in combination). Accordingly, like element numbers are used to identify like parts of the converters 400 and 615 of FIGS. 4 and 6. The power converter 600 is further coupled to an AC grid 630, similar to the AC grid 430, and another example of the AC load/source 130.

The control structure for the single-phase inverter shown in FIG. 5 and FIGS. 6A-6B includes a rotational reference frame (e.g., the dq0 reference frame) control cascaded with per phase (or phase leg) MPC control. In the illustrated example, the rotational reference frame control is performed by the central controller 550, while the per phase (or phase leg) MPC control is performed by local controllers 560a-b. For example, for the dq0 reference frame control, firstly, the DC voltage controller 570 is cascaded with the d component of the grid current (i_{g,d}) controller 572 to provide the d component reference for the output capacitor voltage MPC control (v_{c,d}*). Secondly, the reactive power (Q) controller 574 is cascaded with the q component of the grid current (i_{g,q}) controller 576 to provide the q component reference for the output capacitor voltage MPC control (v_{c,q}*). Thirdly, the zero sequence controller 578 is responsible for the common mode voltage stabilization and second harmonic injection derivation, and generates the zero sequence reference of the MPC control (v₀*).

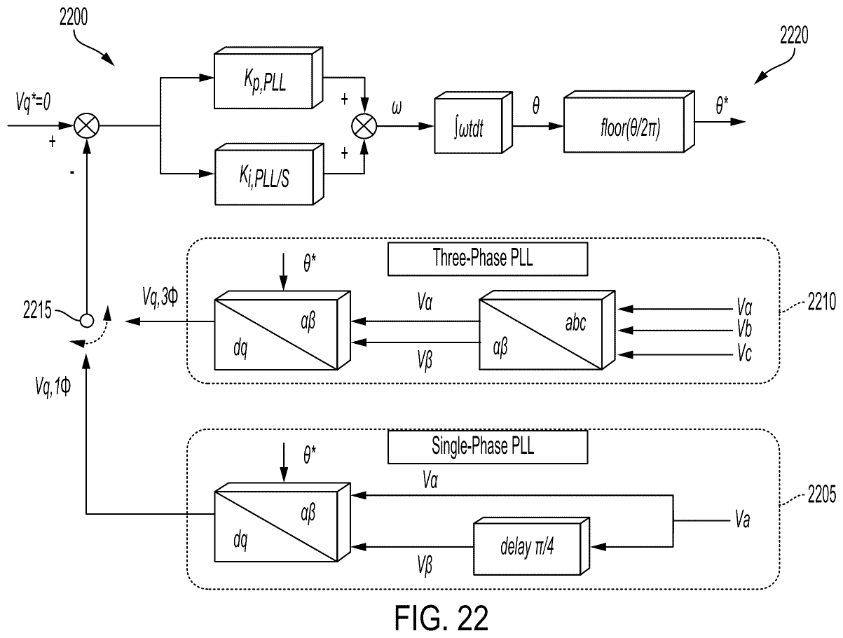

Each of the controllers 570, 572, 574, and 576 may be a regulator that implements a PI control, PID control, or other regulation control technique that provides an output reference target (e.g., i_{g,d}*, i_{g,q}*, v_{c,d}*, v_{c,q}*, or v₀*) based on a difference between an input reference target and an actual value (e.g., a value that is sensed or estimated from a sensed value), where the output reference target is generally selected by each respective controller to ultimately adjust the actual value towards the input reference target. For example, the grid controller 576 determines or receives a difference between i_{g,q}* (an input reference target) and i_{g,q}, (an actual value), and generates an output reference target v_{c,q}* to steer the actual value (i_{g,q}) to track (i_{g,q}*). As shown in FIGS. 6A-6B, in some examples, vdc is a voltage measured across DC bus nodes 405a, 405b and/or capacitor 403, phase angle theta (θ) is generated by phase locked loop (PLL) block 640 of the control system 505, and i_{L,dq0}, v_{c,dq0}, and i_{g,dq0} are generated by a translator 645 of the control system 505. An example of the PLL block 640 is described in further detail with respect to FIG. 22 (see PLL translator 2205). The translator 645 receives sensed or estimated values i_{L,ab}, v_{c,ab}, and i_{g,ab} (e.g., from sensors), and translates these values from the stationary (ab) reference frame to a rotational (dq0) reference frame (e.g., using the Park-Clarke transform) to generate i_{L,dq0}, v_{c,dq0}, and i_{g,dq0}. These values are then provided to the various controllers of the control system 505, as illustrated in FIGS. 6A-6B. These sensed, estimated, and/or translated values (e.g., i_{L,ab}, v_{c,ab}, i_{g,ab} i_{L,dq0}, v_{c,dq0}, i_{g,dq0}, and v_{cf}_{^{Vdc}}) may be referred to as electrical operational characteristics of a converter (e.g., of the converter 615). In some examples, the local controllers 160, 560a,b provide one or more of the electrical operational characteristics in the stationary (ab) reference frame to the control system 505. For example, sensors (e.g., the sensor(s) 140) associated with the local controllers 160, 560a,b may sense these values in real time, and the local controllers 160, 560a,b may transmit these values to the control system 505 in real time over a communication bus.

With respect to the d component and q component control, the DC bus voltage reference (v_{dc}*) and reactive power reference (Q*) may be received by the central controller 550, e.g., from a memory (see, e.g., memory 157 of FIG. 1) or via an input received via an I/O interface (see, e.g., above discussion of commands received via I/O interface 142). In some examples, the DC bus voltage (v_{dc}) can be controlled to any desired value that is higher than the AC grid side peak voltage. In some examples, the reactive power (Q) can also be configured to a value specified by a user. In some examples, the reactive power is controlled to follow, e.g., linear or curve functions according to grid side variations, for example, to conform to a grid service requirement of an applicable standard (e.g., IEEE 1547). Generally, reactive power (Q) may be defined or calculated by the equation: Q=0.5((v_{c,q}×i_{g,d})−(v_{c,d}×i_{g,q})).

A translator block 580 may receive the output capacitor voltage references v_{c,d}*, v_{c,q}*, and v₀* (also written as [symbol] ) from the controllers 572, 576, 578, respectively. The translator block 580 may then translate the output capacitor voltage references, [symbol] , from dq0 reference frame to a stationary reference frame (e.g., the ab reference frame) for the per phase output capacitor voltage MPC control. The outputs of the translator block 580 may be referred to as control reference targets. The local MPC controllers 560a-b receive the sampled AC inductor current, i_{L,ab}, lower capacitor voltage, v_{Cf,ab}, grid current, i_{g,ab}, from an analog to digital converter (ADC) (e.g., from sensors 140) and lower capacitor voltage reference, [symbol] from an output of the upper level cascaded grid current controller/zero sequence derivation. In some examples, the MPC is executed explicitly with a pre-configured piecewise affine function to generate the desired duty cycle for the per phase switching modulation.

For the digital execution of MPC, the state space equations can be configured as

$${i}_{L} ( k + 1 ) = {i}_{L} ( k ) - \frac{{T}_{s}}{{L}_{fs}} {u}_{c} ( k ) + \frac{{v}_{DC} {T}_{s}}{{L}_{fs}} d ( k ) \qquad ( 5 )$$

$${v}_{Cf} ( k + 1 ) = \frac{{T}_{s}}{{c}_{f}} {i}_{L} ( k ) + {v}_{C f} ( k ) - \frac{{T}_{s}}{{c}_{f}} {i}_{g} ( k ) . \qquad ( 6 )$$

The standardized matrix format can be expressed as

$${X}_{k + 1} = {AX}_{k} + {Bu}_{k} + {Ee}_{k} \qquad ( 7 )$$

where A=[1, −Tₛ/L_{fs}; Tₛ/C_{f},1], B=[Tₛ/L_{fs}; 0], E=[0; −Tₓ/C_{f}], Xₖ=[i_{L}(k); v_{Cf}(k)], uₖ=[v_{Dc}d(k)] and eₖ=[i_{g}k].

The cost function is composed of two items

$$min {\sum }_{k = 0}^{{N}_{c}} {\tilde{X}}_{k}^{T} Q {\tilde{X}}_{k} + {\sum }_{k = 0}^{{N}_{p} - 1} Δ {u}_{k}^{T} R Δ {u}_{k} \qquad ( 8 )$$

$$where {\tilde{X}}_{k} = [ {i}_{L}^{*} ( k ) - {i}_{L} ( k ) ; {v}_{Cf}^{*} ( k ) - {v}_{Cf} ( k ) ] ,$$

Δuₖ=uₖ−uₖ₋₁ and Q, R represent the weighting matrices for the tracking error and input variable terms in the cost function. In some examples, the weighting of

$${v}_{Cf}^{*} ( k ) - {v}_{Cf} ( k )$$

in \tilde{X}ₖ is configured to be 100-500 times larger than other terms to track the lower output capacitor voltage references more accurately. Each MPC controller 560a, 560b may thus generate control signals 620a, 620b to control the switches 402a,b, 404a,b (M1, M2, M3, M4) of respective ΦA and ΦB phase legs of the converter 615 to control the capacitor voltage (v_{Cf,a},v_{Cf,b}) to track the output capacitor voltage reference

$$( {v}_{Cf , a}^{*} , {v}_{Cf , b}^{*} )$$

provided by the translator 580. In some examples, the control signals 620a, 620b (collectively, control signal 620) are pulse-width modulated (PWM) signals having a duty cycle and switching frequency. The duty cycle of control signal 620a may be referred to as duty cycle a (or duty_a) and the duty cycle of control signal 620b may be referred to as duty cycle b (or duty_b). The MPC controllers 560a, 560b may determine the duty cycle a and duty cycle b, respectively, based on the aforementioned equations (5)-(8). Additionally, in some examples, the MPC controllers 560a, 560b determine the respective switching frequencies for the control signals 620a, 620b. To determine the switching frequencies, the MPC controllers 560a, 560b may implement a variable frequency soft switching technique in which the switching frequencies are calculated in real-time to ensure soft switching of the switch pairs M1, M2 and M3, M4. In other examples, the MPC controllers 560a, 560b may implement hard switching-based control. In some examples, the control signal 620a may be provided to the switch 402a, and an inverted version of the control signal 620a may be provided to the switch 404a; and the control signal 620b may be provided to the switch 402b, and an inverted version of the control signal 620b may be provided to the switch 404b.

The zero sequence component of the output capacitor voltage MPC reference provided to the translator 580,

$${v}_{Cf , 0}^{*}$$

(e.g., in FIGS. 6A-6B), which is used by the translator 580 to generate the output capacitor voltage reference

$$( {v}_{Cf , a}^{*} , {v}_{Cf , b}^{*} )$$

provided to the MPC controllers 560a, 560b, is composed of two terms, zero sequence offset voltage reference of half DC bus averaged voltage, v_{DC}/2, and the calculated second harmonic injection, v_{2nd}:

$${v}_{Cf , 0}^{*} = {v}_{DC} / 2 + {v}_{2 nd} . \qquad ( 9 )$$

Accordingly, the per phase output capacitor voltage MPC controllers (e.g., 560a, 560b) can regulate and track the desired second harmonic injection, v_{2nd}, with more stable operation and higher bandwidth to achieve the second order power decoupling. For example, as illustrated, no extra notch filter or resonant controller is used to damp the second pulsation. Also, the MPC improves the dynamic performance with higher control bandwidth, faster response time and less transient oscillation. An example of a detailed control diagram using the second harmonic injection, as described herein, is shown in FIGS. 6A-6B.

### Second Harmonic Injection Derivation

In some examples, the MPC-regulated second harmonic injection derivation in the zero sequence control branch of the control structure uses direct calculation based on the balanced charging/discharging between the AC/DC capacitors. For example, as illustrated, no extra notch filter or band-pass filter is used to filter out or extract the second harmonic component. The control bandwidth is improved, for example, due to the combination of direct calculation and MPC regulation. The control technique transfers the second pulsation from the DC side capacitor, C_{dc}, to the output lower capacitors, C_{f,lo} for the purpose of stabilizing the DC side second pulsation.

With reference to FIGS. 5-6, the zero sequency control branch may include the zero sequence derivation controller 578 and a second harmonic injection controller 582. The control system 105, 505, via the second harmonic injection controller 582, may derive the desired second harmonic injection based on three components: angle speed, phase shift, and amplitude. In FIGS. 5-6, a component calculation logic block 584 of the second harmonic injection controller 582 may calculate these three components, and a second order deification logic block 586 may calculate the second harmonic injection based on these three components.

Firstly, the calculation logic block 584 may derive the angle speed of the second harmonic injection as twice of the grid line frequency, 2ω₀, according to the calculation in (4).

Secondly, the calculation logic block 584 may calculate the phase shift, α, of the second harmonic injection based on the angular difference between the vectors of

$${i}_{g , d}^{*} and {i}_{g , q}^{*}$$

by following

$$α = arctan \frac{{i}_{g , d}^{*}}{{i}_{g , q}^{*}} . \qquad ( 10 )$$

Thirdly, the calculation logic block 584 may derive the amplitude of the second harmonic injection, Vₐₘₚ, based on the balanced charging/discharging between the AC/DC capacitors, C_{dc} and C_{f,lo}. To balance the second pulsation energy between the AC/DC capacitors, the voltage ripples should satisfy the following charging/discharging equation

$$\frac{1}{2} {C}_{dc} Δ {v}_{DC}^{2} = 2 ( \frac{1}{2} {C}_{f , lo} Δ {v}_{Cf}^{2} ) . \qquad ( 11 )$$

The voltage ripple on the DC bus capacitor, Δv_{DC}, can be expressed as

$$Δ {v}_{DC} = \frac{{V}_{AC , grid} {I}_{AC , grid}}{2 {ω}_{0} {C}_{dc} {v}_{DC , avg}} . \qquad ( 12 )$$

where v_{DC,avg} and ω₀ are the averaged DC bus voltage and grid line frequency, respectively. Then, the desired amplitude Vₐₘₚ of the second harmonic injection on the AC output capacitor voltage can be derived from (11) and (12) as

$${V}_{amp} = \frac{{V}_{AC , grid} {I}_{AC , grid}}{{ω}_{0} {v}_{DC , avg} \sqrt{8 {C}_{dc} {C}_{f , lo}}} . \qquad ( 13 )$$

Finally, the second order derivation logic block 586 can calculate the desired second harmonic injection using the expression

$${v}_{2 nd} = {V}_{amp} cos ( 2 {ω}_{0} t + α + ϵ ) , \qquad ( 14 )$$

which can be leveraged for the per phase MPC control and regulation. The term of E represents the phase shift constant by considering the initial difference of sine or cosine functions.

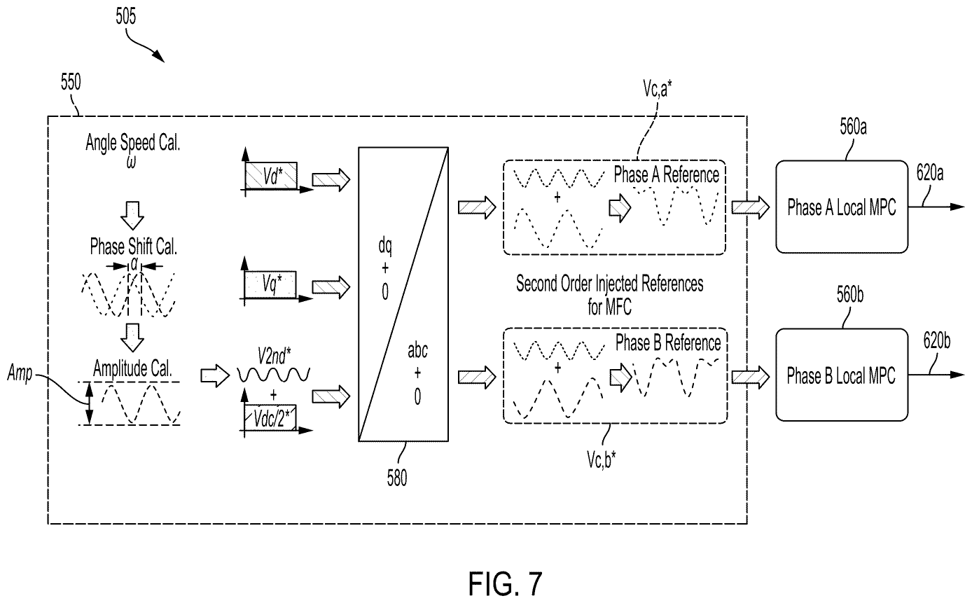

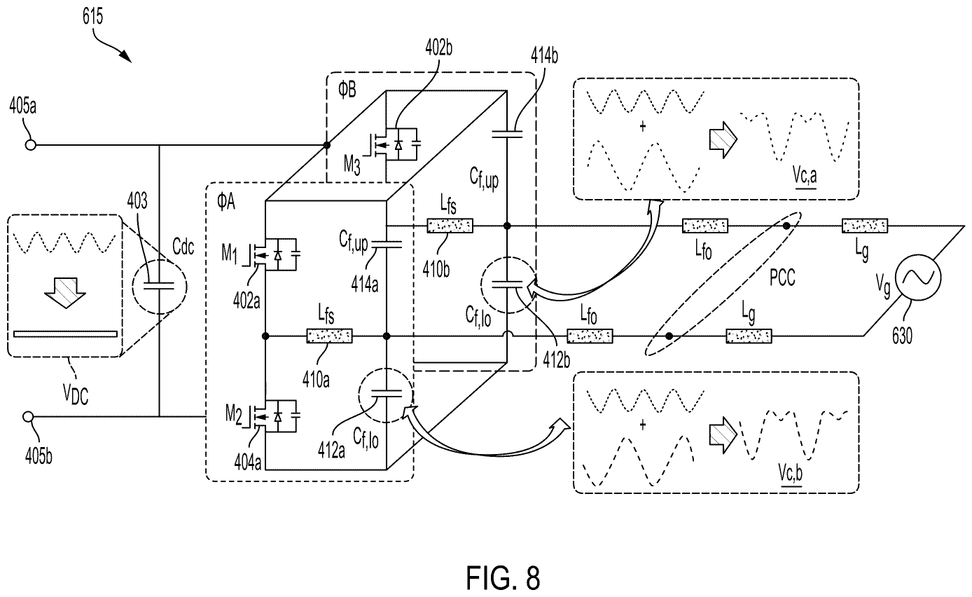

FIGS. 7 and 8 provide additional illustrations of an operating mechanism of the injected second harmonics and the corresponding physical components. More particularly, FIG. 7 illustrates the control system 505 including the controller 550 and local controllers 560a, 560b, where the controller 550 is shown with waveforms to illustrate examples of signals calculated and/or generated by the controller 550. Similarly, FIG. 8 illustrates the converter 615 with waveforms for v_{DC}, v_{c,a}, and v_{c,b} to illustrate examples of signals resulting from the control described with respect to FIGS. 5-6.

### Control Performance Analysis

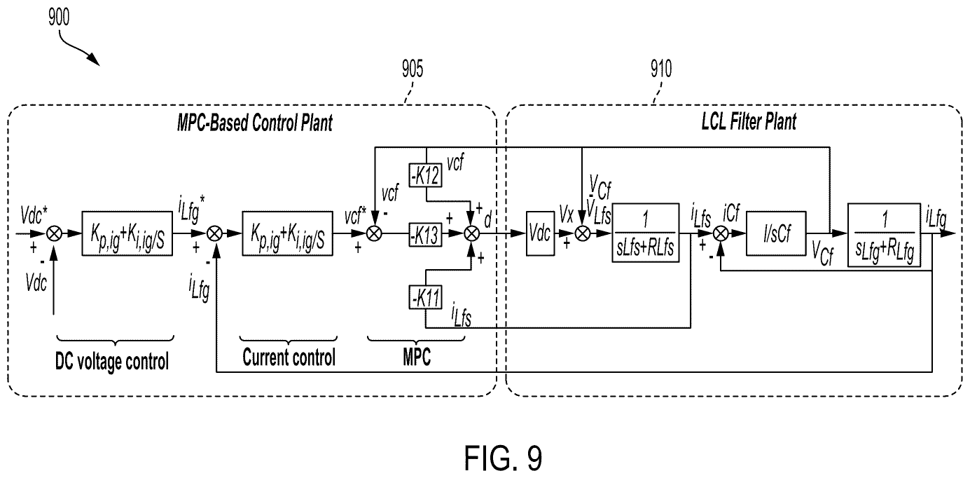

The MPC-based second harmonic injection (MPC-SHI) can provide improved control performance of the transfer functions, for example, as evidenced by the detailed analysis below. A detailed control diagrams of the MPC-SHI control technique is illustrated in FIGS. 6A-6B, and the corresponding control plant model 900 is shown in FIG. 9. The control plant model 900 includes MPC-based control plant 905 and LCL filter plant 910. As illustrated, the MPC-SHI control technique integrates the directly calculated second harmonic component into the reference of MPC regulation, and no extra notch/band-pass filters are included. Thus, the control bandwidth is increased and transient performance is improved with faster rise time, less overshoot.

For the proposed MPC-SHI control technique in FIGS. 6A-6B, because the second pulsation on the DC bus can be largely attenuated through MPC regulation, the dq branches of the DC bus and reactive power controllers are not influenced by the second pulsation. Thus, compared with a traditional PI method, no second order notch filter on dq or band-pass filter on zero sequence control branches is needed or used to improve the output power quality. The control bandwidth and dynamic performance can both be improved, accordingly.

For benchmark with the traditional PI method, the transfer function of the d component DC bus voltage control branch in FIG. 9 from the output capacitor voltage reference,

$${v}_{Cf}^{*} ,$$

to the grid current measurement, i_{g}, is derived below as

$${G}_{vCfref 2 ig , MPC} ( s ) = \frac{{G}_{vCferr 2 vCf , MPC} ( s )}{[ 1 + {G}_{vCferr 2 vCf , MPC} ( s ) ] ( {sL}_{fg} + {R}_{Lfg} )} \qquad ( 18 )$$

where G_{vCferr2vCf,MPC}(s) is the transfer function from the output capacitor voltage tracking error,

$${v}_{Cf , err}^{*} ,$$

to the output capacitor voltage measurement, v_{Cf}, and R_{Lfg} is the equivalent resistance of the grid side inductor.

Then, the transfer function from grid current tracking error, i_{g,err}, to the grid current measurement, i_{g}, is further calculated as

$${G}_{igerr 2 ig , MPC} ( s ) = {G}_{vCfref 2 ig , MPC} ( s ) \cdot {G}_{ig , PI} ( s ) \qquad ( 19 )$$

where G_{ig,PI}(s) is the grid current control transfer function.

Then, the transfer function from DC bus voltage tracking error, v_{DC,err}, to the grid current measurement, i_{g}, is derived as

$${G}_{vDCerr 2 ig , MPC} ( s ) = \frac{{G}_{igerr 2 ig , MPC} ( s ) \cdot {G}_{vDC , PI} ( s )}{1 + {G}_{igerr 2 ig , MPC} ( s )} \qquad ( 20 )$$

where G_{vDC,PI}(s) is the DC bus voltage control transfer function.

Finally, the transfer function from the DC bus voltage reference,

$${v}_{DC}^{*} ,$$

to the grid current measurement, i_{g}, in FIG. 9, can be expressed as

$${G}_{vDCref 2 ig , MPC} ( s ) = \frac{{G}_{vDCerr 2 ig , MPC} ( s )}{1 + {G}_{vDCerr 2 ig , MPC} ( s )} . \qquad ( 21 )$$

### Frequency Domain Comparison

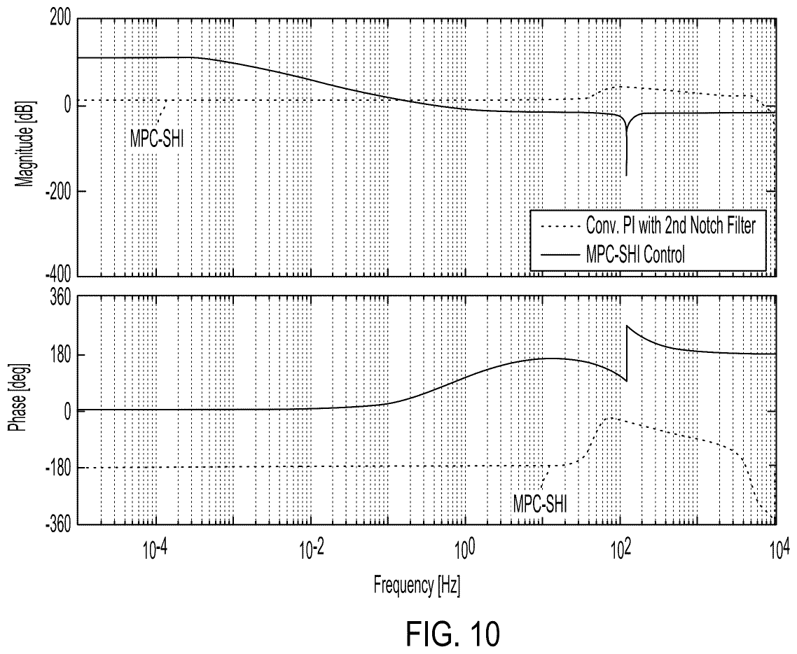

FIG. 10 illustrates bode plots that demonstrate the DC bus voltage tracking error, v_{DC,err}, to the grid current measurement, i_{g}. The bode plots of FIG. 10 illustrate that the MPC-SHI control technique has higher control bandwidth than the conventional notch filtered PI method. Due to the influence of the second order pulsation notch filter, the magnitude drops distinctly at the frequency around 2ω₀ and above. Thus, the dynamic performance can be deteriorated with less flexibility to adjust the control gains. However, the MPC-SHI control technique attenuates the second pulsation without generating extra resonant spikes. The corresponding control bandwidth can be largely increased with more flexibility to increase the control gain while maintained stabilized.

The MPC-SHI control technique has been validated experimentally to show: (1) steady state performance of DC side second pulsation attenuation; (2) improved transient performance and more robust behavior with MPC regulation; (3) low leakage current and reduced total harmonic distortion (THD) in the AC output side; and (4) less passive and active component cost. A 1 kW single-phase inverter test bench is connected to the grid simulator for the validation. The switching frequency is 80 kHz. The LCL filter parameters are 45 μH for switch side inductance, 24 μF for AC side capacitance, 45 μH for grid side inductance and 144 μF for DC side capacitance. The power switches are C3M0021120K SiC from Cree. The micro-controller is TMS320F28379D from TI.

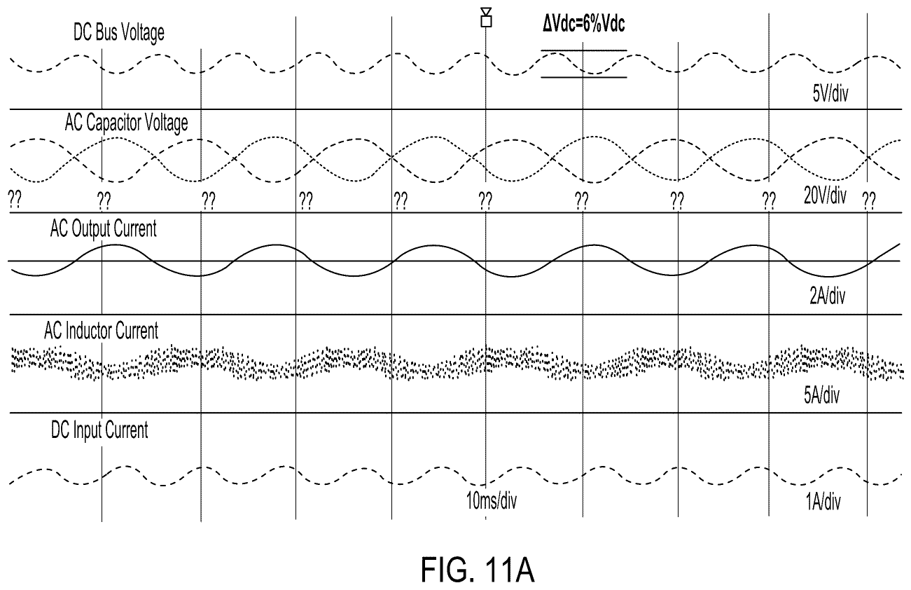

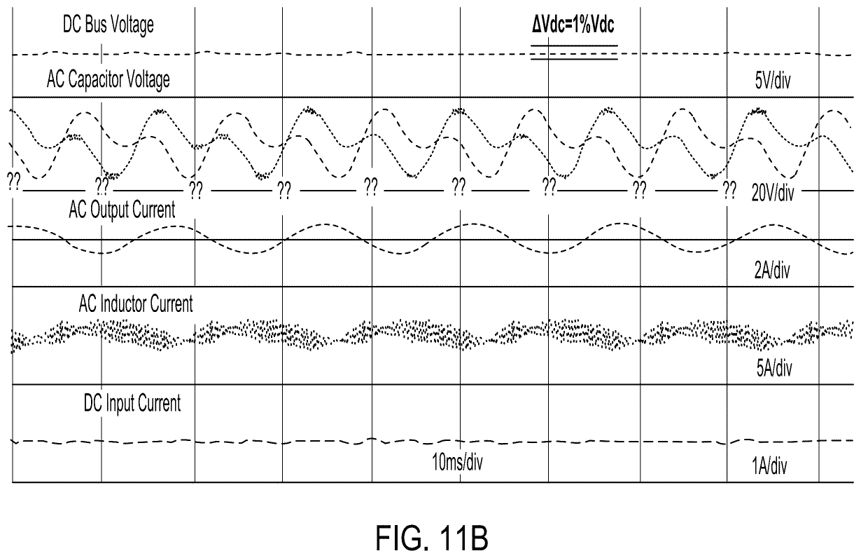

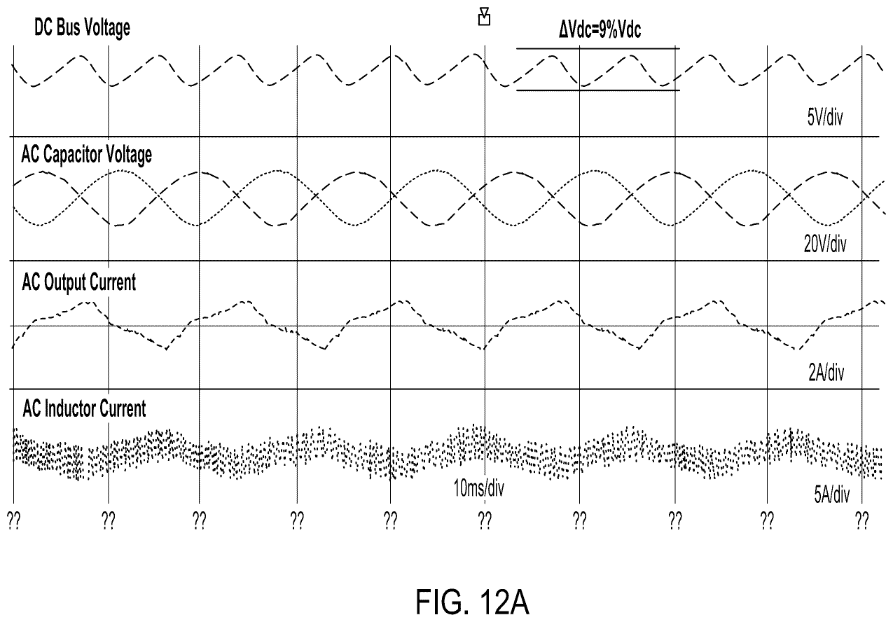

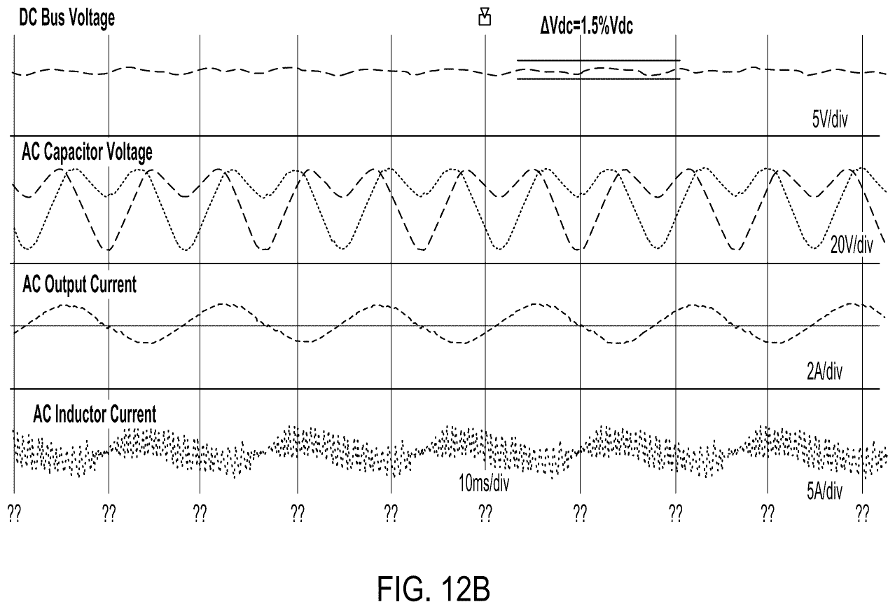

For the DC side second pulsation attenuation, FIGS. 11A-11B show the steady state performance of DC bus voltage, AC capacitor voltage, AC output current, AC inductor current and DC input current without and with the MPC-SHI method for the single-phase inverter by connecting the DC bus to a DC voltage source power supply. FIGS. 12A-12B demonstrate the steady state performance of DC bus voltage, AC capacitor voltage, AC output current and AC inductor current without and with the MPC-SHI method for the single-phase inverter by floating the DC bus. It can be seen that the DC second pulsation voltage ripple, Δv_{DC}, has been reduced by 6 times from 6% to 1% and 9% to 1.5%, respectively.

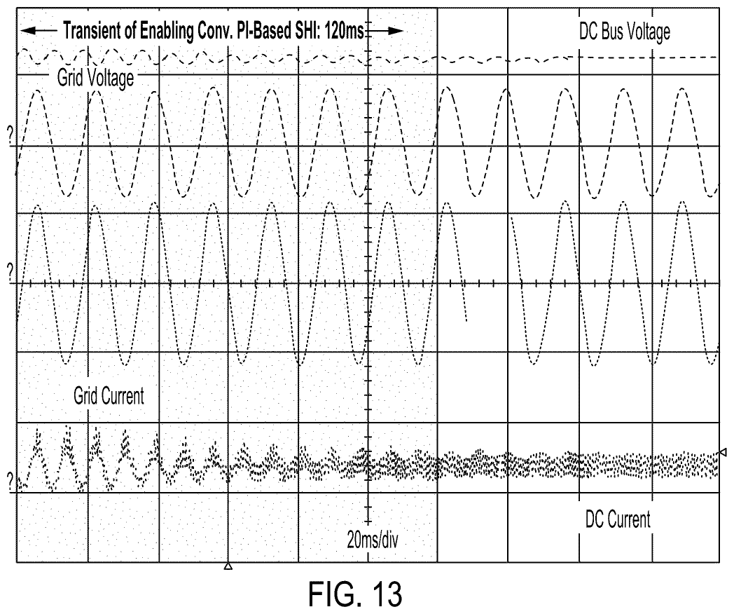

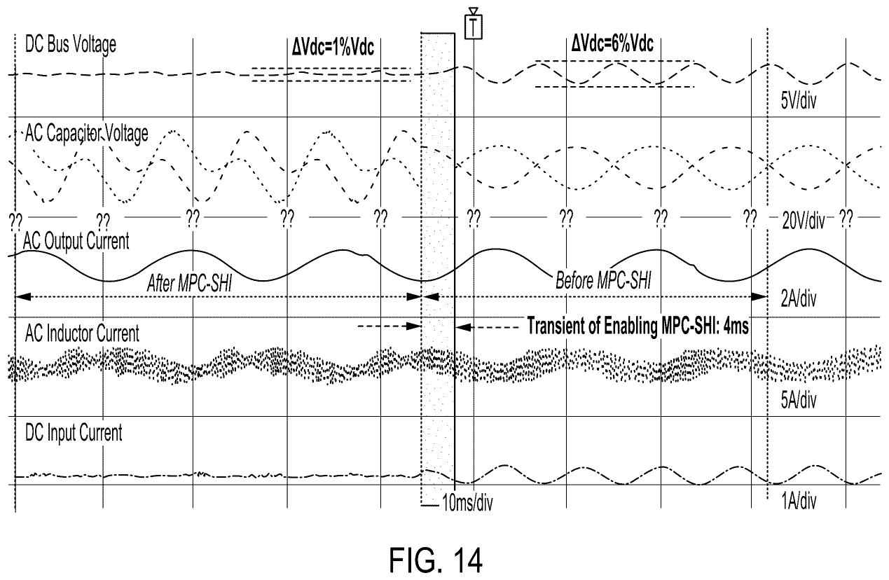

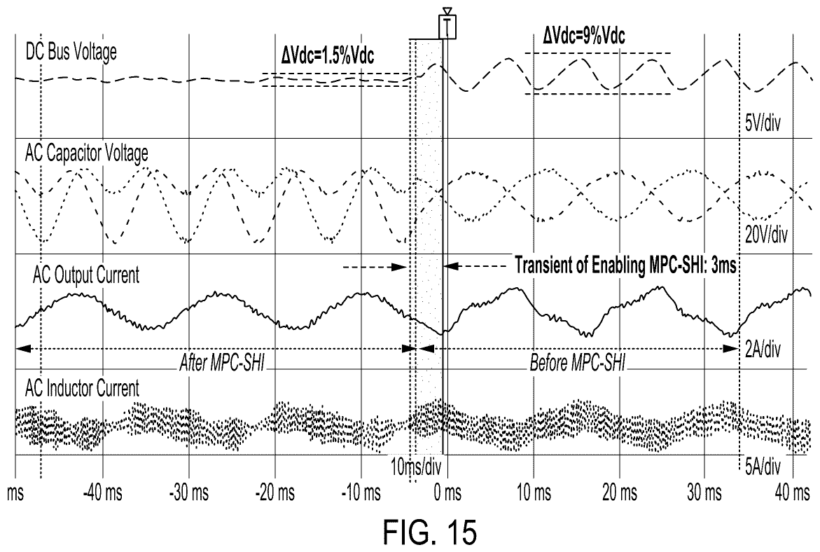

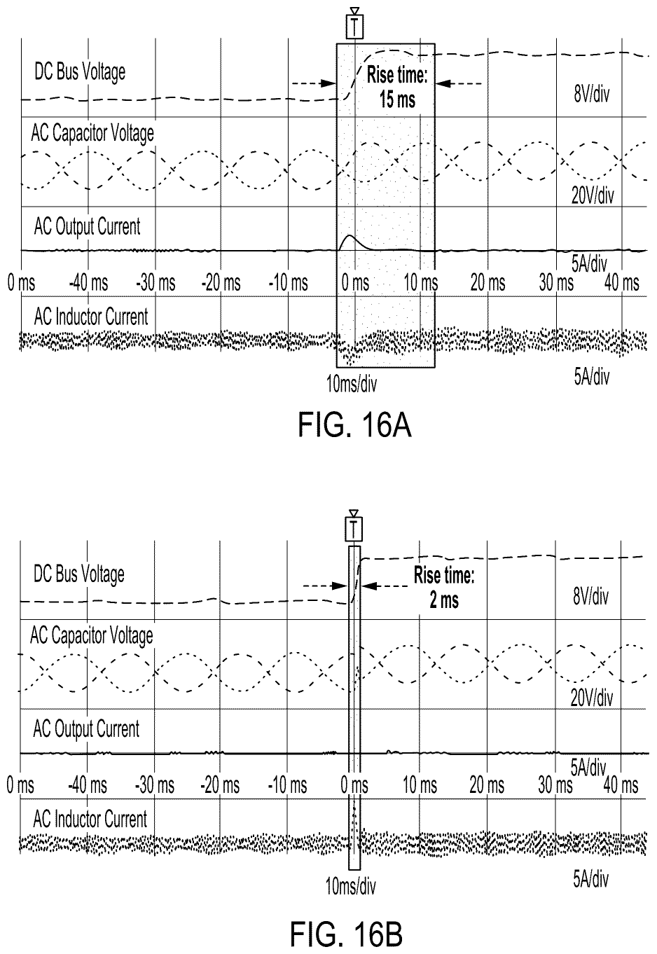

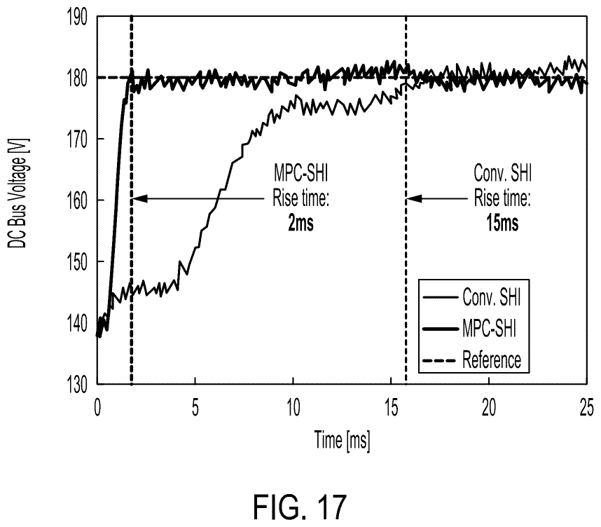

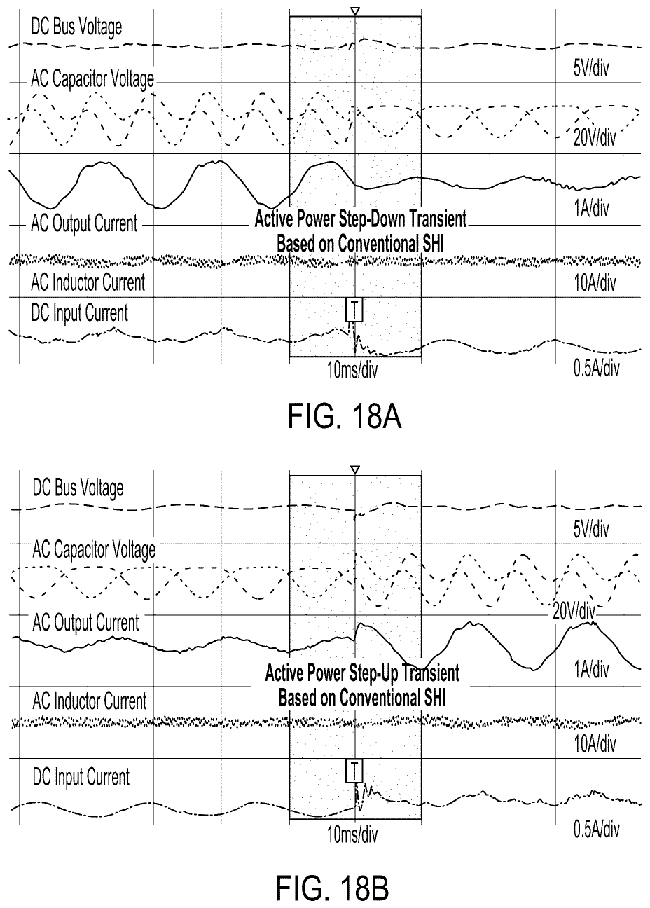

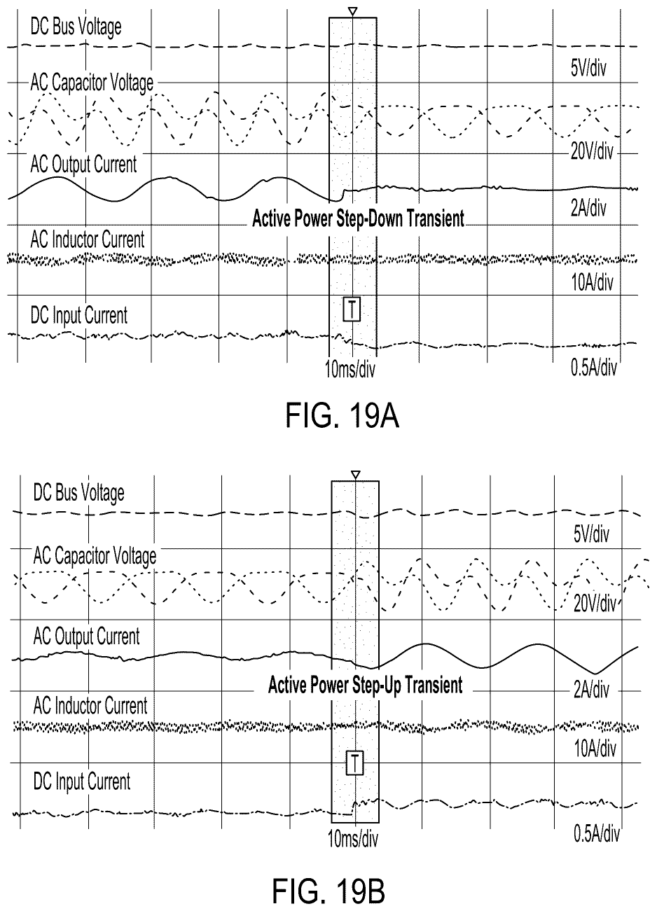

For the transient performance, since MPC-based SHI improves the control bandwidth with more flexibility to enhance the control gain, the rise time and overshoot are both significantly reduced compared with the conventional PI-based control method. FIG. 13 shows the transient performance of DC bus voltage, AC grid voltage, AC output current and DC input current of a conventional PI-based second harmonic injection method. FIG. 14 and FIG. 15 demonstrate the transient periods of DC bus voltage, AC capacitor voltage, AC output current and AC inductor current by enabling the MPC-SHI control technique with DC power supply connection and floating DC bus, respectively. It can be seen the transient period of the conventional PI lasts for 120 ms. The MPC-SHI control technique can largely shorten the transient period by 40 times to only 3 ms without oscillation. Also, FIGS. 16A-16B show a comparison between the conventional PI and the MPC-SHI control technique with a DC bus voltage reference step-up of 40V. The MPC-SHI control technique reduces the transient period from 15 ms to 2 ms, which can also be reflected in the captured ADC data in FIG. 17. Additionally, FIGS. 18A-B demonstrates the transient performance with an active power reference step-down and step-up for the conventional PI-based SHI control method. The transient is oscillating with big overshoot. However, the MPC-SHI control technique improves the transient performance of active power reference step-down and step-up with less rise time and oscillation which is shown in FIGS. 19A-B.

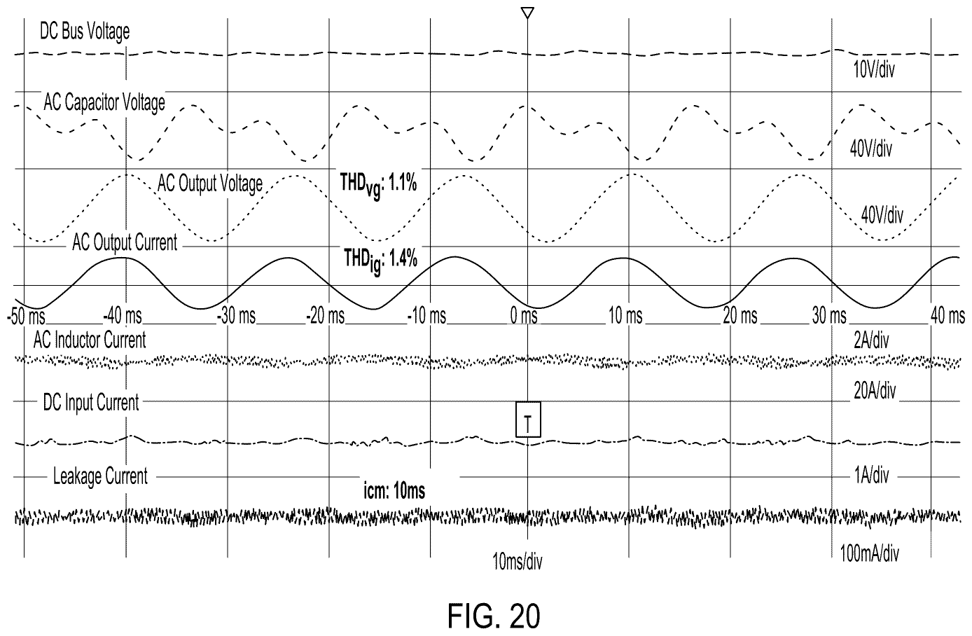

The MPC-SHI control technique attenuates both the DC side second pulsation and leakage current. At the same time, the output side voltage and current are not deteriorated. The injected second order harmonics are restricted to circulate within the switch side LC filter. The grid voltage and current are not distorted with low THD. FIG. 20 shows the grid voltage/current and leakage current waveforms. The THD of grid voltage/current are kept below 1.5% and the leakage current is within 10 mA.

Accordingly, some examples described herein provide an MPC-regulated second harmonic injection technique for a power converter, for example, a single-phase or split-phase inverter, to attenuate the DC side second harmonic pulsation. In some examples, the calculated second harmonic injection is integrated with MPC to improve the dynamic performance. Because the directly calculated second harmonic component is regulated by the MPC controller before injecting to the output capacitor, the disclosed control techniques can improve the stability of the single-phase energy conversion system, among other provided benefits.

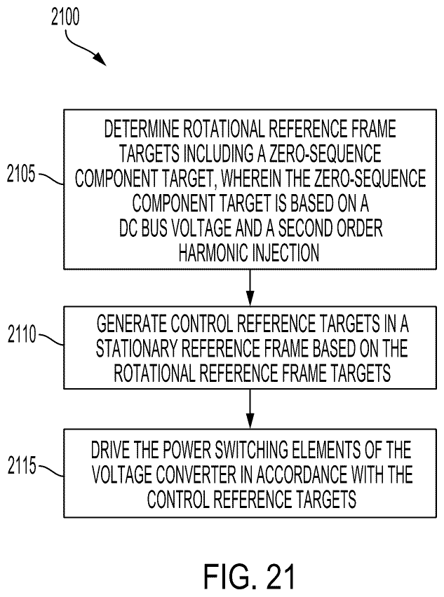

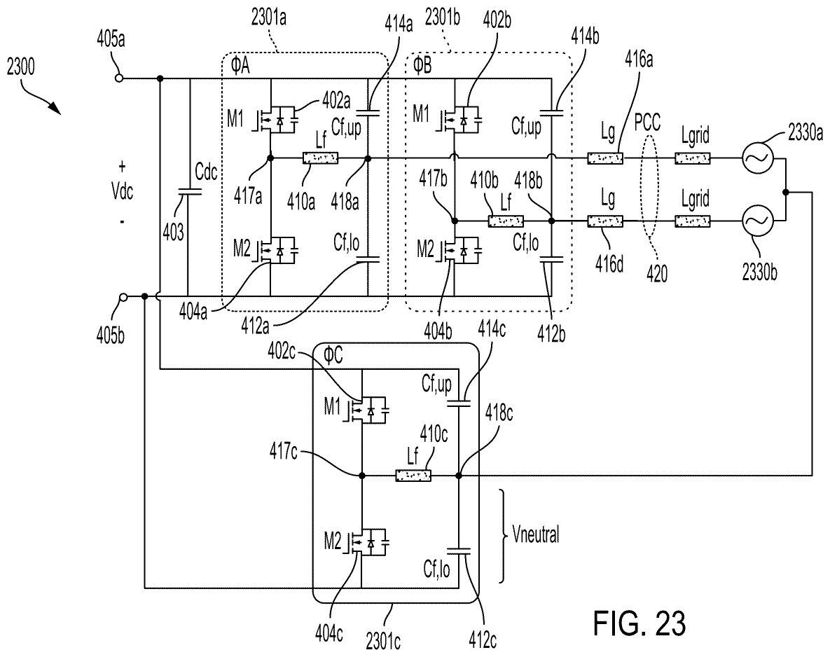

In FIG. 21, a process 2100 for converting voltage using second order harmonic injection is provided. The process 2100 is described as being carried out by the power converter system 100 implemented as the power converter system 600 of FIGS. 6A-6B. However, in some embodiments, the process 2100 is implemented by another power converter system or by the power converter system 100 implementing another power converter system (e.g., the power converter 400 of FIG. 4, a split-phase power converter (see converter 2300 of FIG. 23), or multiphase power converter (e.g., software-configured to perform as a single-phase or split-phase power converter)). Additionally, although the blocks of the process 2100 are illustrated in a particular order, in some embodiments, one or more of the blocks may be executed partially or entirely in parallel, may be executed in a different order than illustrated in FIG. 21, or may be bypassed.

In block 2105, a control system determines rotational reference frame targets including a zero-sequence component target, wherein the zero-sequence component target is determined based on a DC bus voltage on the DC bus and a second order harmonic injection. The second order harmonic injection is determined based on a second order harmonic of a frequency of an AC signal of the AC voltage section. For example, with reference to FIGS. 1, 5, and 6, the control system 105, 505 (e.g., via the central controller 150, 550) may determine rotational reference frame targets v_{c,d}*, v_{c,q}*, and v₀*, as illustrated in and previously described with respect to FIGS. 5 and 6. The zero-sequence component target (v₀*) may be generated by the central controller 150, 550, as previously described. For example, the central controller 150, 550 may calculate the zero-sequence component target based on summing two components (i) the DC offset (e.g., Vdc/2) and (ii) a second order harmonic injection (e.g., v_{2nd}* in FIGS. 5 and 6). Additionally, the central controller 150, 550 may calculate the second order harmonic based on, for example, an angle speed (CO), phase shift (α), and/or amplitude (Amp) as described above.

In block 2110, the control system generates control reference targets in a stationary reference frame based on the rotational reference frame targets. For example, with reference to FIGS. 1, 5, and 6, the control system 105, 505 (e.g., via the central controller 150, 550) translates, via a dq0/ab translator (e.g., translator 180), the rotational reference frame targets to control reference targets in the stationary reference frame. In particular, the dq0/ab translator receives the rotational reference frame targets v_{c,d}*, v_{c,q}*, and v₀* and translates these targets from the dq0 rotational reference frame to the ab stationary reference frame to generate control reference targets v_{c,a}* and v_{c,b}*. The dq0/ab translator may perform the translation using the inverse Park-Clarke transform. The dq0 rotational reference frame includes a direct axis (D-axis), a quadrature axis (Q-axis), and null axis (0-axis).

In block 2115, the control system drives the power switching elements of the power converter in accordance with the control reference targets. For example, with reference to FIGS. 1, 5, and 6, the control system 105, 505, via local controllers 160 (e.g., local controllers 560a and 560b in FIGS. 5-6) drive the power switching elements of the converter 115, 600 based on the control reference targets v_{c,a}*, v_{c,b}*, and v_{c,c}* received from the central controller 150. For example, each of the local controllers 160 may output control signals (e.g., control signals 620a, 620b) to the power switching elements 402a,b and 404a,b. The local controllers 160 may generate the control signals to drive the power switching elements M1-M4 using various techniques, as provided herein, including, for example, MPC-based control (see FIGS. 5-6), PID control, or PI control.

In some examples, another rotational reference frame other than the dq0 reference frame is used by the control system 105, 505 in implementing the process 2100.

The process 2100 can be used to control the power converter in a rectifying mode (converting AC to DC power) as well as in an inverting mode (inverting DC to AC power). For example, the process 2100 can be used for rectification and inverting when the DC bus of the power converter is floating without being connected to a DC power supply. In this case, the power flow direction (from AC to DC or DC to AC) can be determined by an extra energy conversion stage of DC-to-DC converter (not shown) between the power converter and DC load/source. When no extra DC to DC converter is connected and the DC bus is directly connected to a DC power supply, a DC bus voltage control block may not be present, and the sign of i_{g,d}* will indicate the direction of power flow, where positive sign means DC to AC and negative sign means AC to DC.

In some examples, the process 2100 can provide power conversion with reduced second order pulsation, store energy in a common mode of the power converter, improved dynamic performance and control bandwidth, lower total harmonic distortion (THD), lower leakage current, enable reduced capacitor size and costs (e.g., of a capacitor(s) on a DC bus of the power converter), and eliminate additional passive or active components that may otherwise be used. In some examples, effectively, the process 2100 balances the power converter system, leverages the common mode for energy storage, and can allow a third harmonic oscillation.

FIG. 22 illustrates a functional block diagram 2200 for performing a conversion from the stationary reference frame to the dq0 rotational reference frame and for determining a reference phase θ* of the AC signal of a power converter (e.g., as shown in FIG. 1, 4, 6, or 7). The diagram 2200 includes functional blocks performed by the control system of a power converter, for example, the control system 105 or 505. The diagram 2200 illustrates a single-phase phase locked loop (PLL) translator 2205 for converting a voltage value (e.g., vₐ) from a stationary reference frame to a rotational reference frame (e.g., dq0 reference frame). For example, as illustrated, the translator 2205 receives a voltage value vₐ and the reference phase angle reference (θ*), and outputs a voltage value v_{q} in the dq0 reference frame. The received voltage value vₐ may be the voltage across a lower capacitor of the LC filter of a leg of the single-phase voltage converter (e.g., v_{c,a} in FIGS. 6A-6B). The voltage value v_{q} may be used to calculate “Q” in the diagram of FIGS. 6A-6B.

The single-phase phase locked loop (PLL) translator 2205 includes a delay block, which may derive v_{β}, and an αβ/dq transform block, which may implement a Park transform.

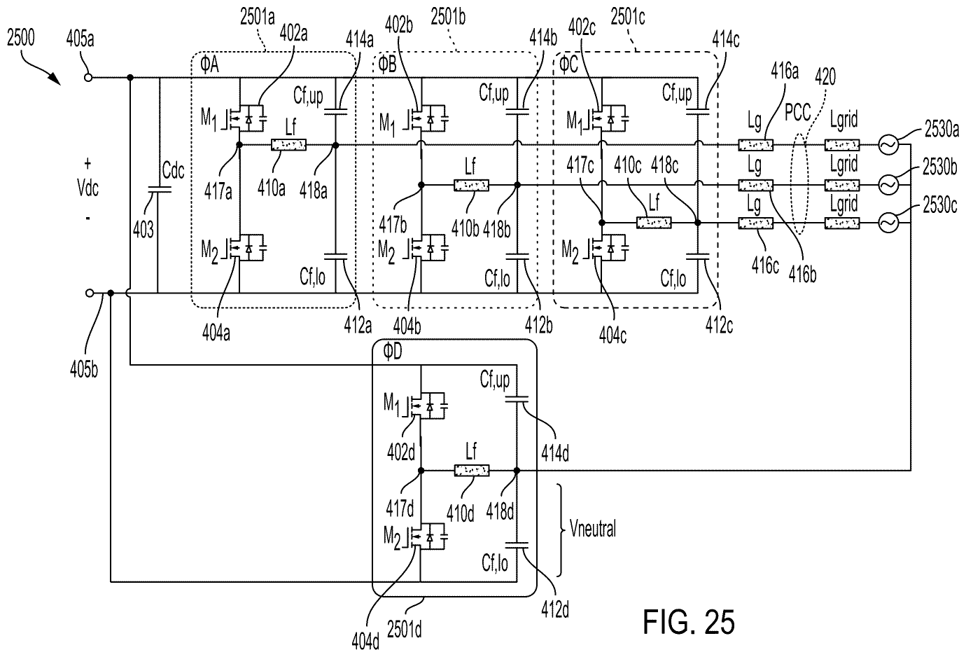

The diagram 2200 further illustrates a three-phase phase locked loop (PLL) translator 2210 for converting voltage values from a stationary reference frame to a rotational reference frame (e.g., the dq0 reference frame). For example, as illustrated, the translator 2210 receives voltage values vₐ, v_{b}, v_{c} and the reference phase angle reference (θ*), and outputs a voltage value v_{q} in the dq0 reference frame. The received voltage values vₐ, v_{b}, v_{c} may be the voltages across lower capacitors of the LC filter of respective phases of the three-phase power converter (see, e.g., c_{f,lo} for phases A, B, and C in FIG. 25), The three-phase phase locked loop (PLL) translator 2210 includes an abc/αβ transform block, which may implement a Clarke transform, and an αβ/dq transform block, which may implement a Park transform. The switch 2215 selects between either the three-phase PLL output from translator 2210 or the single-phase PLL output from translator 2205 (e.g., based on whether the control system is controlling a three-phase or single-phase converter). The function blocks 2220 determine and output the reference phase angle reference (θ*), which is used by the three-phase PLL 2210 and the single-phase PLL 2205.

In some examples, the control system implementing the function blocks of the diagram 2200 (e.g., the controls system 105 or 505) includes both the three-phase PLL 2210 and the single-phase PLL 2205. In other examples, the control system implementing the function blocks of the diagram 2200 (e.g., the controls system 105 or 505) includes one, but not both, of the three-phase PLL 2210 or the single-phase PLL 2205.

FIG. 23 illustrates a split-phase power converter 2300, according to some examples. The power converter 2300 is an example of the power converter 115 and LC filter 120 (in combination) of FIG. 1. The power converter 2300 is coupled to a split-phase AC grid including an AC grid phase 2330a and AC grid phase 2330b, which may each be phase-shifted 180 degrees from one another. The split-phase AC grid is an example of the AC source/load 130 (FIG. 1). The power converter 2300 is a split-phase converter and includes a first phase leg (ΦA) 2301 coupled to AC grid phase 2330a and a second phase leg (ΦB) 2301b coupled to AC grid phase 2330b, and a (third) neutral phase leg (ΦC) 2301c coupled to a node joining the AC grid phases 2330a and 2330b. As illustrated, each phase leg of the split-phase power converter 2300 may include power switching elements and a filter similar to the phase legs of the converters 400 and 600; accordingly, similar element numbers are used for like elements in FIGS. 4, 6, and 23, with a “c” being added for components of the neutral phase leg ΦC in place of an “a” or “b.”

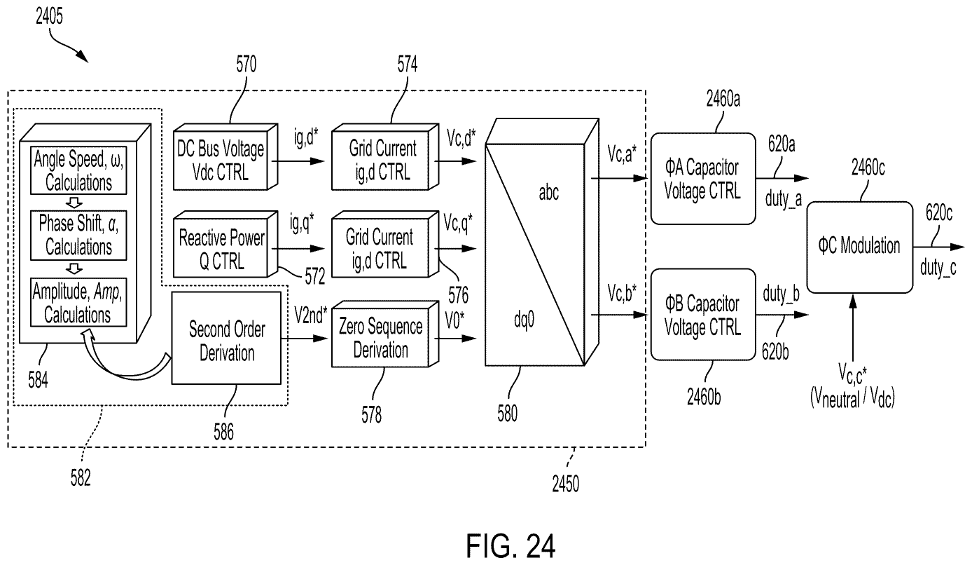

The split-phase power converter 2300 may be controlled by the control system 105 (see FIG. 1) implementing second harmonic injection, as described herein. For example, FIG. 24 illustrates a control system 2405, which is an example of the control system 105, that may be used to control the power converter 2300 to implement the second harmonic injection, as described herein. In the illustrated example, the control system 2405 includes a central controller 2450, which is an example of the central controller 150, and local controllers 2460a and 2460b, which are examples of the local controllers 160. In some examples, a single controller e.g., (the central controller 150) executes the control structure or functions illustrated in FIG. 24.

The control structure for the split-phase converter shown in FIG. 24 is similar to the control structure of FIGS. 5 and 6, and includes a rotational reference frame (e.g., the dq0 reference frame) control cascaded with per phase (or phase leg) MPC control. Accordingly, the discussion of the control structure of FIGS. 5 and 6A-6B similarly apply to FIG. 24, except as otherwise noted. In particular, in contrast to the control structure of FIGS. 5 and 6, the control system 2405 further includes a C phase leg controller 2460c. The C phase leg controller 2460c receives neutral voltage reference, v_{c,c}* (also referred to as a neutral leg control reference target), as a reference, which is equal to neutral voltage (voltage across the lower capacitor of the C leg) over DC bus voltage (i.e., v_{c,c}*=vₙₑᵤₜᵣₐₗ/v_{DC}). The C phase leg controller 2460c then generates a control signal 620c to control the switches 402c, 404c. For example, the control signal 620c, like the control signals 620a, 620b may be a PWM signal having a duty cycle and a switching frequency. The C phase leg controller 2460c may determine the duty cycle c (or duty_c) for this PWM signal to control the neutral voltage (v_{c,c}) to track the neutral voltage reference (v_{c,c}*). For example, the C phase leg controller 2460c may be a regulator that implements an MPC control, PI control, PID control, or other regulation control technique to perform such control. Additionally, in some examples, the C phase leg controller 2460c may determine the switching frequency for the control signal 620c, for example, to achieve soft switching or hard switching. In some examples, the control signal 620a may be provided to the switch 402a, and an inverted version of the control signal 620a may be provided to the switch 404a; the control signal 620b may be provided to the switch 402b, and an inverted version of the control signal 620b may be provided to the switch 404b; and the control signal 620c may be provided to the switch 402c, and an inverted version of the control signal 620c may be provided to the switch 404c. Although not illustrated in FIG. 24, the control system 2405 may, similar to the control system 505, include a PLL block 640 and translator 645 to perform similar functionality as described above with respect to FIG. 6. Additionally, the local controllers 2460a-c may determine and transmit one or more electrical operational characteristics of the converter 2300 to the control system 2405, similar to the local controllers 560a-b.

As noted above, the split-phase power converter 2300 may be used implement the process 2100. For example, the control system 2405 of FIG. 24 may execute the process 2100 of FIG. 21 to control the split-phase power converter 2300 of FIG. 23. In executing the process 2100, in block 2110, the control system 2405 may further generate control reference target v_{c,c}* (as discussed above), and, in block 2115, may further drive the power switching elements of the C phase leg in accordance with this control reference target v_{c,c}* (e.g., using the control signal 620c output by local controller 2460c).

FIG. 25 illustrates a three-phase power converter 2500, according to some examples. The power converter 2500 is an example of the power converter 115 and LC filter 120 (in combination) of FIG. 1. The power converter 2500 is coupled to a three phase AC grid including an AC grid phase 2530a, AC grid phase 2530b, and AC grid phase 2530c, which may each be phase-shifted 120 degrees from one another. The three phase AC grid is an example of the AC source/load 130 (FIG. 1). The power converter 2500 is a three-phase converter and includes a first phase leg (ΦA) 2501A coupled to AC grid phase 2530a, a second phase leg (ΦB) 2501b coupled to AC grid phase 2530b, a third phase leg (ΦC) 2501c coupled to AC grid phase 2530c, and a (fourth) neutral phase leg (ΦD) 2501d coupled to a node joining the AC grid phases 2530a, 2530b, and 2530c. As illustrated, each phase leg of the three-phase power converter 2500 may include power switching elements and a filter similar to the phase legs of the converters 400 and 600; accordingly, similar element numbers are used for like elements in FIGS. 4, 6, and 25, with a “c” being added for components of the third phase leg ΦC and a “d” being added for components of the neutral phase leg ΦD in place of an “a” or “b.”

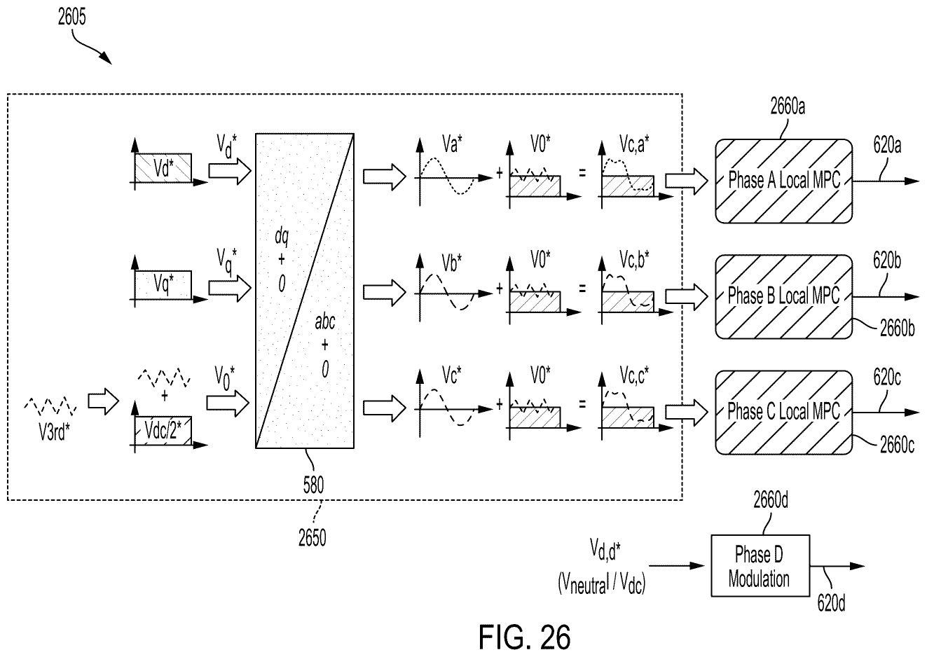

The three-phase power converter 2500 may be controlled by the control system 105 (see FIG. 1) implementing second harmonic injection, as described herein. For example, FIG. 26 illustrates a control system 2605, which is an example of the control system 105, that may be used to control the power converter 2500 to implement a harmonic injection, as described herein. In the illustrated example, the control system 2605 includes a central controller 2650, which is an example of the central controller 150, and local controllers 2660a, 2660b, and 2660c, which are examples of the local controllers 160. In some examples, a single controller e.g., (the central controller 150) executes the control structure or functions illustrated in FIG. 26.

The control structure for the three-phase converter shown in FIG. 26 is similar to the control structure of FIGS. 5 and 6, and includes a rotational reference frame (e.g., the dq0 reference frame) control cascaded with per phase (or phase leg) MPC control. Accordingly, the discussion of the control structure of FIGS. 5 and 6A-6B similarly apply to FIG. 26, except as otherwise noted. In particular, in contrast to the control structure of FIGS. 5 and 6, the control system 2605 further includes a C phase leg controller 2660c and a D phase leg controller 2660d. The C phase leg controller 2660c receives a reference voltage v_{c,c}* as a reference, which is a reference for the voltage across the lower capacitor 412c of the C leg that is output by the translator 580. Thus, a similar technique as described with respect to FIGS. 5 and 6A-B may be used to provide the translator 580 the reference voltage v_{d}* and v_{q}*, and a modified technique (discussed further below) may be used to provide v₀* to the translator 580, and then the translator 580 may perform the inverse Park-Clarke transform to generate the reference voltages in the stationary (abc) reference frame (that is, v_{c,abc}*). In contrast, in the FIGS. 5, 6A, and 6B single phase inverter example, the “c” component of the transformed reference voltages may be not generated or may be ignored. The D phase leg controller 2660d receives a neutral voltage reference, v_{d,d}*(also referred to as a neutral leg control reference target), as a reference, which is equal to neutral voltage (voltage across the lower capacitor of the D leg) over DC bus voltage (i.e., v_{d,d}*=vₙₑᵤₜᵣₐₗ/v_{DC}).

The C and D phase leg controllers 2460c and 2460d then generate control signals 620c and 620d, respectively, to control (drive) the switches 402c,d, 404c,d. For example, the control signals 620c and 620d, like the control signals 620a, 620b may be a PWM signal having a duty cycle and a switching frequency. The C phase leg controller 2460c may determine the duty cycle c (or duty_c) for this PWM signal to control the voltage (v_{c,c}) to track the voltage reference (v_{c,c}*). Similarly, the D phase leg controller 2460d may determine the duty cycle d (or duty_d) for this PWM signal to control the neutral voltage (v_{c,d}) to track the neutral voltage reference (v_{c,d}*). For example, the C and D phase leg controllers 2460c, 2460d may be regulators that implement an MPC control, PI control, PID control, or other regulation control technique to perform such control. Additionally, in some examples, the C and D phase leg controllers 2460c, 2460d may determine the switching frequency for the respective control signals 620c, 620d, for example, to achieve soft switching or hard switching. In some examples, the control signal 620a may be provided to the switch 402a, and an inverted version of the control signal 620a may be provided to the switch 404a; the control signal 620b may be provided to the switch 402b, and an inverted version of the control signal 620b may be provided to the switch 404b; the control signal 620c may be provided to the switch 402c, and an inverted version of the control signal 620c may be provided to the switch 404c; and the control signal 620c may be provided to the switch 402d, and an inverted version of the control signal 620d may be provided to the switch 404d. Although not illustrated in FIG. 26, the control system 2605 may, similar to the control system 505, include a PLL block 640 and translator 645 to perform similar functionality as described above with respect to FIGS. 6A-6B. Additionally, the local controllers 2660a-d may determine and transmit one or more electrical operational characteristics of the converter 2500 to the control system 2605, similar to the local controllers 560a-b.

In some examples, the control system 2605 of FIG. 26 may execute the process 2100 of FIG. 21, modified as noted herein, to control the three-phase power converter 2500 of FIG. 23. In particular, to implement the process 2100 to control the three-phase power converter 2500, the control system 2605, in block 2105, the zero-sequence component target (v₀*) may be determined based on a DC bus voltage and a third order harmonic injection, rather than second order harmonic injection. In executing the process 2100, in block 2110, the control system 2605 may further generate control reference target v_{d,d}* (as discussed above) of the D phase leg in accordance with this control reference target v_{d,d}* (e.g., using the duty cycle output by local controller 2660d). Otherwise, the control system 2605 may execute blocks 2110 and 2115 in a similar manner as discussed above.

The third order harmonic may be a sinusoidal injection for a third harmonic injection (Sin-RTHI), which may be derived from a third order of grid fundamental frequency (θ). The Sin-RTHI zero-sequence voltage reference can be expressed as:

$${v}_{0 , 3 rd}^{*} = {v}_{dc} / 2 + {V}_{m} {D}_{3 rd} sin ( 3 ω t ) .$$

Thus, the abc frame Sin-RTHI three-phase capacitor voltage references,

$${v}_{c , abc}^{*} ,$$

distributed to the local controllers 160a-c can be expressed as

$${v}_{c , a}^{*} = {v}_{c , a}^{*} + {V}_{m} {D}_{3 rd} sin ( 3 ω t )$$

$${v}_{c , b}^{*} = {v}_{c , b}^{*} + {V}_{m} {D}_{3 rd} sin ( 3 ( ω t - \frac{2 π}{3} ) )$$

$${v}_{c , c}^{*} = {v}_{c , c}^{*} + {V}_{m} {D}_{3 rd} sin ( 3 ( ω t + \frac{2 π}{3} ) ) .$$

where Vₘ and D_{3rd} are the amplitude of fundamental component and third harmonic injection depth, respectively. The angular speed, ω, and phase shift can be derived based on fundamental frequency theta (θ). A phase-locked loop (PLL) controller (see FIG. 22) of the central controller 150 may provide theta (θ) to provide real-time phase angle information of the AC voltage (e.g., grid or AC motor voltage). For example, a PI controller may be used to control the q component of the grid voltage, v_{g,q}, to be zero to derive the angular velocity, ω, of the phase angle. Then, theta (θ) can be calculated with a period of 2π, and based on the active/reactive power calculation in

$$[ \begin{matrix}P \\ Q\end{matrix} ] = \frac{3}{2} [ \begin{matrix}{u}_{g , d} & {u}_{g , q} \\ {u}_{g , q} & - {u}_{g , d}\end{matrix} ] [ \begin{matrix}{i}_{g , d} \\ {i}_{g , q}\end{matrix} ]$$

where the d-axis and q-axis represent the active and reactive power, respectively. Specifically, theta (θ) can be derived by accumulating the product of control time period, Ts, and angular velocity, ω, in each control period and by performing a modulus operator function to ensure the theta (θ) is within [0,2pi].

In this three-phase converter example of FIGS. 25 and 26, the third harmonic injection improves the DC bus utilization with less required DC bus voltage, and the neutral D phase leg is connected to the three-phase grid neutral to provide unbalanced grid support. For example, this third harmonic injection can be leveraged in unbalanced operation of the three-phase power converter (e.g., in a grid forming mode or when coupled with an unbalanced load in three phase operation).

In some examples, the power converter system 100 is a multiphase power converter that is, for example, software-configured to perform as a single-phase or split-phase power converter (e.g., as d described with respect to FIG. 4 and FIG. 23), and/or as a three-phase converter (e.g., as described with respect to FIG. 25) at different instances in time. For example, the power converter system 100 may have the hardware illustrated in FIG. 25 to enable three-phase operation, but may disable certain elements (e.g., by not controlling switching elements of particular phase legs) to enable operation in single- or split-phase operation, and may control contactors (e.g., transistors, relays, etc.) to provide appropriate connections as illustrated in FIGS. 4, 23, and 25 for the particular operation mode.

Performing the various techniques and operations described herein may be facilitated by an electronic controller (e.g., a processor-based computing device), such as, for example, a central controller 150, local controller 160, local MPC controller 560a-b, controller 550, 2405, 2450, 2460a-c, 2605, 2650, 2640a-d, or the like as described herein. Such an electronic controller may include a processor-based device such as a computing device, and so forth, that may include a central processor unit (CPU) or a processing core. In addition to the CPU or processing core, the system includes main memory, cache memory, and bus interface circuits. The electronic controller may include a memory storage device, such as a hard drive (solid state hard drive, or other types of hard drive), or flash drive associated with the computer system. The electronic controller may further include a keyboard, or keypad, or some other user input interface, and a monitor, e.g., an LCD (liquid crystal display) monitor, that may be placed where a user can access them.

The electronic controller is configured to facilitate, for example, the implementation of a power converter (e.g., by controlling the switching devices of, for example, a power converter system). The storage device may thus include a computer program product that when executed on the electronic controller (which, as noted, may be a processor-based device) causes the processor-based device to perform operations to facilitate the implementation of procedures and operations described herein. The electronic controller may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the electronic controller. Other modules that may be included with the electronic controller may include a user interface to provide or receive input and output data. The electronic controller may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

### EXAMPLES

Example 1: A method, apparatus, and/or non-transitory computer-readable medium storing processor-executable instructions for a power converter system comprising: a power converter with a direct current (DC) voltage section including a DC bus and an alternating current (AC) voltage section including AC connection nodes, the power converter including power switching elements; and a control system configured to control the power converter, the control system configured to: determine rotational reference frame targets, the rotational reference frame targets including a zero-sequence component target, wherein the zero-sequence component target is based on a DC bus voltage on the DC bus and a second order harmonic injection, wherein the second order harmonic injection is determined based on a second order harmonic of a frequency of an AC signal of the AC voltage section; generate control reference targets in a stationary reference frame based on the rotational reference frame targets; generate control signals for the power switching elements based on the control reference targets; and drive the power switching elements in accordance with the control signals.

Example 2: The method, apparatus, and/or non-transitory computer readable medium of Example 1, wherein the control system is further configured to: store energy, based on the driving of the power switching elements in accordance with the control reference targets, in a common mode of the power converter to reduce a second order harmonic pulse on the DC bus.

Example 3: The method, apparatus, and/or non-transitory computer readable medium of Example 1 or 2, wherein the second order harmonic injection is a periodic signal derived based on the second order harmonic of the frequency of the AC signal, a phase shift that is based on current of the AC signal, and an amplitude that is based on a voltage relationship between a DC bus capacitor across the DC bus and a filter capacitor of an LC filter of the AC voltage section.

Example 4: The method, apparatus, and/or non-transitory computer readable medium of any of Examples 1 to 3, wherein the second order harmonic injection is a sinusoidal signal having a frequency of two times the frequency of the AC signal.

Example 5: The method, apparatus, and/or non-transitory computer readable medium of any of Examples 1 to 4, where the control system is a cascaded control system comprising: a central controller including a processing unit, the central controller configured to: determine the rotational reference frame targets, and generate the control reference targets; and at least one local controller, each of the at least one local controller including a local processing unit, each of the at least one local controller configured to: receive a control reference target of the control reference targets, and drive a portion of the power switching elements, associated with the local controller, in accordance with the control reference target.

Example 6: The method, apparatus, and/or non-transitory computer readable medium of Example 5, wherein, to drive the portion of the power switching elements in accordance with the control reference target, each of the at least one local controller is configured to: implement model predictive control (MPC) to generate control signaling for the portion of the power switching elements.

Example 7: The method, apparatus, and/or non-transitory computer readable medium of any of Examples 5 to 6, wherein the central controller is further configured to: receive at least one electrical operational characteristic from each of the at least one local controller, the electrical operational characteristics in the stationary reference frame; convert the at least one electrical operational characteristic to the rotational reference frame; and determine a direct axis (D-axis) component and a quadrature axis (Q-axis) component of the rotational reference frame targets based on the at least one electrical operational characteristic in the rotational reference frame.

Example 8: The method, apparatus, and/or non-transitory computer readable medium of Example 7, wherein the central controller is further configured to: determine the frequency of the AC signal based on a first characteristic of the at least one electrical operational characteristic in the rotational reference frame.

Example 9: The method, apparatus, and/or non-transitory computer readable medium of any of Examples 1 to 8, wherein, to determine the direct axis (D-axis) component and the quadrature axis (Q-axis) component of the rotational reference frame targets based on the at least one electrical operational characteristic in the rotational reference frame, the central controller is configured to: convert a current value indicative of a signal from the AC section of the power converter to a direct axis (D-axis) current component and a quadrature axis (Q-axis) current component in the rotational reference frame, generate a D-axis voltage component, as the D-axis component of the rotational reference frame targets, based on a comparison of the D-axis current component to a desired D-axis current, and generate a Q-axis voltage component, as the Q-axis component of the rotational reference frame targets, based on a comparison of the Q-axis current component to a desired Q-axis current; and wherein, to generate the control reference targets in the stationary reference frame based on the rotational reference frame targets, the central controller is further configured to: convert the D-axis voltage component, Q-axis voltage component, and the zero-sequence component target to the stationary reference frame.

Example 10: The method, apparatus, and/or non-transitory computer readable medium of any of Examples 1 to 9, wherein the zero-sequence component target includes a sum of a DC offset that is based on the DC bus voltage and the second order harmonic injection.

Example 11: The method, apparatus, and/or non-transitory computer readable medium of any of Examples 1 to 10, wherein the DC offset is half the DC bus voltage.

Example 12: The method, apparatus, and/or non-transitory computer readable medium of any of Examples 1 to 11, wherein the power converter is a single-phase power converter having a first phase leg coupled to a first node of the AC connection nodes and a second phase leg coupled to a second node of the AC connection nodes, wherein the first phase leg includes a first pair of power switching elements of the power switching elements and a first LC filter, and wherein the second phase leg includes a second pair of power switching elements of the power switching elements and a second LC filter.

Example 13: The method, apparatus, and/or non-transitory computer readable medium of Example 12, wherein first phase leg includes a first midpoint node and the first pair of power switching elements includes a first high-side switching element and a first low side switching element that are connected at the first midpoint node, wherein second phase leg includes a second midpoint node and the second pair of power switching elements includes a second high-side switching element and a second low side switching element that are connected at the second midpoint node.

Example 14: The method, apparatus, and/or non-transitory computer readable medium of Example 13, wherein the first LC filter is coupled to the first midpoint node and includes a first inductor coupled between the first midpoint node and a first filter node, a first upper capacitor coupled between the first filter node and a positive DC bus node of the DC bus, and a first lower capacitor coupled between the first filter node and a negative DC bus node of the DC bus, wherein the second LC filter is coupled to the second midpoint node and includes a second inductor coupled between the second midpoint node and a second filter node, a second upper capacitor coupled between the second filter node and the positive DC bus node of the DC bus, and a second lower capacitor coupled between the second filter node and the negative DC bus node of the DC bus.

Example 15: The method, apparatus, and/or non-transitory computer readable medium of any of Examples 1 to 14, wherein the power converter is one or more of an AC-to-DC rectifier and a DC-to-AC inverter.

Example 16: The method, apparatus, and/or non-transitory computer readable medium of any of Examples 1 to 15, wherein the power converter is incorporated into an electric vehicle, and wherein the control system is further configured to drive the power switching elements in accordance with the control signals to rectify the AC signal received via the AC connection nodes and output DC charging power via the DC bus to charge an electric vehicle battery.

Example 17: The method, apparatus, and/or non-transitory computer readable medium of Example 16, wherein, subsequent to rectifying the AC signal, the control system is further configured to drive the power switching elements in accordance with the control signals to invert DC power from the electric vehicle battery and output the AC signal via the AC connection nodes.

Example 18: The method, apparatus, and/or non-transitory computer readable medium of any of Examples 1 to 17, wherein the control system is configured to drive the power switching elements in accordance with the control signals to convert AC signal to DC power for the DC bus in grid following operation.

Example 19: The method, apparatus, and/or non-transitory computer readable medium of any of Examples 1 to 18, wherein the control system is configured to drive the power switching elements in accordance with the control signals to invert DC power from the DC bus and output the AC signal in grid forming operation.

Example 20: The method, apparatus, and/or non-transitory computer readable medium of any of Examples 1 to 19, wherein the power converter is at least one selected from a group of: a single-phase power converter, a multi-phase power converter, and a split-phase power converter.

Example 21: The method, apparatus, and/or non-transitory computer readable medium of any of Examples 1 to 20, wherein the power converter is a split-phase power converter having a first phase leg coupled to a first AC phase, a second phase leg coupled to a second AC phase, and a neutral phase leg coupled to a midpoint between the first AC phase and the second AC phase, wherein the first phase leg includes a first pair of power switching elements of the power switching elements and a first LC filter, wherein the second phase leg includes a second pair of power switching elements of the power switching elements and a second LC filter, and wherein the neutral phase leg includes a third pair of power switching elements and a third LC filter.

Example 22: The method, apparatus, and/or non-transitory computer readable medium of Example 21, wherein the control system is further configured to: determine a neutral leg control reference target based on a voltage across a capacitor of the third LC filter and the DC bus voltage; generate control signals for the third pair of power switching elements based on the neutral leg control reference target; and drive the third pair of power switching elements in accordance with the control signals for the third pair of power switching elements.

Example 23: A method, apparatus, and/or non-transitory computer-readable medium storing processor-executable instructions for a power converter system comprising: a three-phase power converter with a direct current (DC) voltage section including a DC bus and an alternating current (AC) voltage section including AC connection nodes, the power converter including four phase legs including a first phase leg, a second phase leg, a third phase leg, and a neutral phase leg, each of the first, second and third phase legs having a respective LC filter and respective power switching elements, and the neutral phase leg having neutral leg power switching elements and a neutral leg LC filter; and a control system configured to control the power converter, the control system configured to: determine rotational reference frame targets, the rotational reference frame targets including a zero-sequence component target, wherein the zero-sequence component target is based on a DC bus voltage on the DC bus and a third order harmonic injection, wherein the third order harmonic injection is determined based on a third order harmonic of a frequency of an AC signal of the AC voltage section; determine a neutral leg reference target based on a ratio of neutral voltage and DC bus voltage; generate control reference targets in a stationary reference frame based on the rotational reference frame targets; drive the power switching elements in accordance with the control reference targets; and drive the neutral leg power switching elements in accordance with the neutral leg reference target.

Example 24: The method, apparatus, and/or non-transitory computer readable medium of Example 23, wherein the third order harmonic injection is a periodic signal derived based on the third order harmonic of the frequency of the AC signal.

Example 25: The method, apparatus, and/or non-transitory computer readable medium of Example 23 or 24, where the control system is a cascaded control system comprising:

Example 26: The method, apparatus, and/or non-transitory computer readable medium of and of Examples 23 to 25,a central controller including a processing unit, the central controller configured to: determine the rotational reference frame targets, and generate the control reference targets; and at least one local controller, each of the at least one local controller including a local processing unit, each of the at least one local controller configured to: receive a control reference target of the control reference targets, and drive a portion of the power switching elements, associated with the local controller, in accordance with the control reference target.

Example 27: The method, apparatus, and/or non-transitory computer readable medium of Example 26, wherein, to drive the portion of the power switching elements in accordance with the control reference target, each of the at least one local controller is configured to: implement model predictive control (MPC) to generate control signaling for the portion of the power switching elements.

Example 28: The method, apparatus, and/or non-transitory computer readable medium of Example 27, wherein the central controller is further configured to: receive at least one electrical operational characteristic from each of the at least one local controller, the electrical operational characteristics in the stationary reference frame; convert the at least one electrical operational characteristic to the rotational reference frame; and determine a direct axis (D-axis) component and a quadrature axis (Q-axis) component of the rotational reference frame targets based on the at least one electrical operational characteristic in the rotational reference frame.

Example 29: The method, apparatus, and/or non-transitory computer readable medium of Example 28, wherein the central controller is further configured to: determine the frequency of the AC signal based on a first characteristic of the at least one electrical operational characteristic in the rotational reference frame

Example 30: The method, apparatus, and/or non-transitory computer readable medium of any of Examples 28 to 29, wherein, to determine the direct axis (D-axis) component and the quadrature axis (Q-axis) component of the rotational reference frame targets based on the at least one electrical operational characteristic in the rotational reference frame, the central controller is configured to: convert a current value indicative of a signal from the AC section of the power converter to a direct axis (D-axis) current component and a quadrature axis (Q-axis) current component in the rotational reference frame, generate a D-axis voltage component, as the D-axis component of the rotational reference frame targets, based on a comparison of the D-axis current component to a desired D-axis current, and generate a Q-axis voltage component, as the Q-axis component of the rotational reference frame targets, based on a comparison of the Q-axis current component to a desired Q-axis current; and wherein, to generate the control reference targets in the stationary reference frame based on the rotational reference frame targets, the central controller is further configured to: convert the D-axis voltage component, Q-axis voltage component, and the zero-sequence component target to the stationary reference frame

Example 31: The method, apparatus, and/or non-transitory computer readable medium of any of Examples 23 to 30, wherein the zero-sequence component target includes a sum of a DC offset that is based on the DC bus voltage and the third order harmonic injection

Example 32: The method, apparatus, and/or non-transitory computer readable medium of Example 31, wherein the DC offset is half the DC bus voltage.

Example 33: The method, apparatus, and/or non-transitory computer readable medium of any of Examples 23 to 32, wherein first phase leg includes a first midpoint node connecting a first high-side switching element and a first low side switching element of the power switching elements of the first phase leg, wherein second phase leg includes a second midpoint node connecting a second high-side switching element and a second low side switching element of the power switching elements of the second phase leg,

Example 34: The method, apparatus, and/or non-transitory computer readable medium of any of Examples 23 to 33, wherein third phase leg includes a third midpoint node connecting a third high-side switching element and a third low side switching element of the power switching elements of the third phase leg, and wherein neutral phase leg includes a fourth midpoint node connecting a fourth high-side switching element and a fourth low side switching element of the neutral leg power switching elements

Example 35: The method, apparatus, and/or non-transitory computer readable medium of any of Examples 23 to 34, wherein the LC filter of the first phase leg is coupled to the first midpoint node and includes a first inductor coupled between the first midpoint node and a first filter node, a first upper capacitor coupled between the first filter node and a positive DC bus node of the DC bus, and a first lower capacitor coupled between the first filter node and a negative DC bus node of the DC bus, wherein the LC filter of the second phase leg is coupled to the second midpoint node and includes a second inductor coupled between the second midpoint node and a second filter node, a second upper capacitor coupled between the second filter node and the positive DC bus node of the DC bus, and a second lower capacitor coupled between the second filter node and the negative DC bus node of the DC bus, wherein the LC filter of the third phase leg is coupled to the third midpoint node and includes a third inductor coupled between the third midpoint node and a third filter node, a third upper capacitor coupled between the third filter node and the positive DC bus node of the DC bus, and a third lower capacitor coupled between the third filter node and the negative DC bus node of the DC bus, and wherein the neutral leg LC filter is coupled to the fourth midpoint node and includes a fourth inductor coupled between the fourth midpoint node and a fourth filter node, a fourth upper capacitor coupled between the fourth filter node and the positive DC bus node of the DC bus, and a fourth lower capacitor coupled between the fourth filter node and the negative DC bus node of the DC bus

Example 36: The method, apparatus, and/or non-transitory computer readable medium of any of Examples 23 to 35, wherein the power converter is one or more of an AC-to-DC rectifier and a DC-to-AC inverter.

Example 37: The method, apparatus, and/or non-transitory computer readable medium of any of Examples 23 to 36, wherein the control system is further configured to: determine a neutral leg control reference target based on a voltage across a capacitor of the neutral leg LC filter and the DC bus voltage; generate control signals for the neutral leg power switching elements based on the neutral leg control reference target; and drive the neutral leg power switching elements in accordance with the control signals for the neutral leg power switching elements.

Example 38: The method, apparatus, and/or non-transitory computer readable medium of any of Examples 1 to 36, wherein the power converter is a non-isolated power converter.

1. A power converter system comprising:
a power converter with a direct current (DC) voltage section including a DC bus and an alternating current (AC) voltage section including AC connection nodes, the power converter including power switching elements; and
a control system configured to control the power converter, the control system configured to:
determine rotational reference frame targets, the rotational reference frame targets including a zero-sequence component target, wherein the zero-sequence component target is based on a DC bus voltage on the DC bus and a second order harmonic injection, wherein the second order harmonic injection is determined based on a second order harmonic of a frequency of an AC signal of the AC voltage section,
generate control reference targets in a stationary reference frame based on the rotational reference frame targets,
generate control signals for the power switching elements based on the control reference targets, and
drive the power switching elements in accordance with the control signals.

2. The power converter system of claim 1, wherein the control system is further configured to:
store energy, based on the driving of the power switching elements in accordance with the control reference targets, in a common mode of the power converter to reduce a second order harmonic pulse on the DC bus.

3. The power converter system of claim 1, wherein the second order harmonic injection is a periodic signal derived based on the second order harmonic of the frequency of the AC signal, a phase shift that is based on current of the AC signal, and an amplitude that is based on a voltage relationship between a DC bus capacitor across the DC bus and a filter capacitor of an LC filter of the AC voltage section.

4. The power converter system of claim 1, wherein the second order harmonic injection is a sinusoidal signal having a frequency of two times the frequency of the AC signal.

5. The power converter system of claim 1, where the control system is a cascaded control system comprising:
a central controller including a processing unit, the central controller configured to:
determine the rotational reference frame targets, and generate the control reference targets; and
at least one local controller, each of the at least one local controller including a local processing unit, each of the at least one local controller configured to:
receive a control reference target of the control reference targets, and
drive a portion of the power switching elements, associated with the local controller, in accordance with the control reference target.

6. The power converter system of claim 5, wherein, to drive the portion of the power switching elements in accordance with the control reference target, each of the at least one local controller is configured to:
implement model predictive control (MPC) to generate control signaling for the portion of the power switching elements.

7. The power converter system of claim 5, wherein the central controller is further configured to:
receive at least one electrical operational characteristic from each of the at least one local controller, the electrical operational characteristics in the stationary reference frame;
convert the at least one electrical operational characteristic to the rotational reference frame; and
determine a direct axis (D-axis) component and a quadrature axis (Q-axis) component of the rotational reference frame targets based on the at least one electrical operational characteristic in the rotational reference frame.

8. The power converter system of claim 7, wherein the central controller is further configured to:
determine the frequency of the AC signal based on a first characteristic of the at least one electrical operational characteristic in the rotational reference frame.

9. The power converter system of claim 7,
wherein, to determine the direct axis (D-axis) component and the quadrature axis (Q-axis) component of the rotational reference frame targets based on the at least one electrical operational characteristic in the rotational reference frame, the central controller is configured to:
convert a current value indicative of a signal from the AC section of the power converter to a direct axis (D-axis) current component and a quadrature axis (Q-axis) current component in the rotational reference frame,
generate a D-axis voltage component, as the D-axis component of the rotational reference frame targets, based on a comparison of the D-axis current component to a desired D-axis current, and
generate a Q-axis voltage component, as the Q-axis component of the rotational reference frame targets, based on a comparison of the Q-axis current component to a desired Q-axis current; and
wherein, to generate the control reference targets in the stationary reference frame based on the rotational reference frame targets, the central controller is further configured to:
convert the D-axis voltage component, Q-axis voltage component, and the zero-sequence component target to the stationary reference frame.

10. The power converter system of claim 1, wherein the zero-sequence component target includes a sum of a DC offset that is based on the DC bus voltage and the second order harmonic injection.

11. The power converter system of claim 10, wherein the DC offset is half the DC bus voltage.

12. The power converter system of claim 1, wherein the power converter is a single-phase power converter having a first phase leg coupled to a first node of the AC connection nodes and a second phase leg coupled to a second node of the AC connection nodes,
wherein the first phase leg includes a first pair of power switching elements of the power switching elements and a first LC filter, and
wherein the second phase leg includes a second pair of power switching elements of the power switching elements and a second LC filter.

13. The power converter system of claim 12,
wherein first phase leg includes a first midpoint node and the first pair of power switching elements includes a first high-side switching element and a first low side switching element that are connected at the first midpoint node,
wherein second phase leg includes a second midpoint node and the second pair of power switching elements includes a second high-side switching element and a second low side switching element that are connected at the second midpoint node.

14. The power converter system of claim 13,
wherein the first LC filter is coupled to the first midpoint node and includes a first inductor coupled between the first midpoint node and a first filter node, a first upper capacitor coupled between the first filter node and a positive DC bus node of the DC bus, and a first lower capacitor coupled between the first filter node and a negative DC bus node of the DC bus,
wherein the second LC filter is coupled to the second midpoint node and includes a second inductor coupled between the second midpoint node and a second filter node, a second upper capacitor coupled between the second filter node and the positive DC bus node of the DC bus, and a second lower capacitor coupled between the second filter node and the negative DC bus node of the DC bus.

15. The power converter system of claim 1, wherein the power converter is one or more of an AC-to-DC rectifier and a DC-to-AC inverter.

16. The power converter system of claim 1, wherein the power converter is incorporated into an electric vehicle, and wherein the control system is further configured to drive the power switching elements in accordance with the control signals to rectify the AC signal received via the AC connection nodes and output DC charging power via the DC bus to charge an electric vehicle battery.

17. The power converter system of claim 16, wherein, subsequent to rectifying the AC signal, the control system is further configured to drive the power switching elements in accordance with the control signals to invert DC power from the electric vehicle battery and output the AC signal via the AC connection nodes.

18. The power converter system of claim 1, wherein the control system is configured to drive the power switching elements in accordance with the control signals to convert AC signal to DC power for the DC bus in grid following operation.

19. The power converter system of claim 1, wherein the control system is configured to drive the power switching elements in accordance with the control signals to invert DC power from the DC bus and output the AC signal in grid forming operation.

20. The power converter system of claim 1, wherein the power converter is at least one selected from a group of: a single-phase power converter, a multi-phase power converter, and a split-phase power converter.

21. The power converter system of claim 1, wherein the power converter is a split-phase power converter having a first phase leg coupled to a first AC phase, a second phase leg coupled to a second AC phase, and a neutral phase leg coupled to a midpoint between the first AC phase and the second AC phase,
wherein the first phase leg includes a first pair of power switching elements of the power switching elements and a first LC filter,
wherein the second phase leg includes a second pair of power switching elements of the power switching elements and a second LC filter, and
wherein the neutral phase leg includes a third pair of power switching elements and a third LC filter.

22. The power converter system of claim 21, wherein the control system is further configured to:
determine a neutral leg control reference target based on a voltage across a capacitor of the third LC filter and the DC bus voltage;
generate control signals for the third pair of power switching elements based on the neutral leg control reference target; and
drive the third pair of power switching elements in accordance with the control signals for the third pair of power switching elements.

23. A method of converting voltage, the method comprising:
determining rotational reference frame targets for a power converter including a direct current (DC) voltage section including a DC bus, an alternating current (AC) voltage section including AC connection nodes, and power switching elements, the rotational reference frame targets including a zero-sequence component target, wherein the zero-sequence component target is determined based on a DC bus voltage on the DC bus and a second order harmonic injection, wherein the second order harmonic injection is based on a second order harmonic of a frequency of an AC signal of the AC voltage section;
generating control reference targets in a stationary reference frame based on the rotational reference frame targets; and
driving the power switching elements of the power converter in accordance with the control reference targets.

24. The method of claim 23, further comprising: storing energy, based on the driving of the power switching elements in accordance with the control reference targets, in a common mode of the power converter to reduce a second order harmonic pulse on the DC bus.

25. The method of claim 23, wherein the second order harmonic injection is a periodic signal derived based on the second order harmonic of the frequency of the AC signal, a phase shift that is based on current of the AC signal, and an amplitude that is based on a voltage relationship between a DC bus capacitor across the DC bus and a filter capacitor of an LC filter of the AC voltage section.

26. The method of claim 23, wherein the second order harmonic injection is a sinusoidal signal having a frequency of two times the frequency of the AC signal.

27. The method of claim 23, further comprising:
determining, by a central controller of a cascaded control system, the rotational reference frame targets;
generating, by the central controller, the control reference targets;
receiving, by each of at least one local controller of the cascaded control system, a control reference target of the control reference targets; and
driving, by each of the at least one local controller, a portion of the power switching elements, associated with the local controller, in accordance with the control reference target.

28.-42. (canceled)

43. The method of claim 23, wherein the power converter is a split-phase power converter having a first phase leg coupled to a first AC phase, a second phase leg coupled to a second AC phase, and a neutral phase leg coupled to a midpoint between the first AC phase and the second AC phase,
wherein the first phase leg includes a first pair of power switching elements of the power switching elements and a first LC filter,
wherein the second phase leg includes a second pair of power switching elements of the power switching elements and a second LC filter, and
wherein the neutral phase leg includes a third pair of power switching elements and a third LC filter, and
wherein the method further comprising:
determining a neutral leg control reference target based on a voltage across a capacitor of the third LC filter and the DC bus voltage;
generating control signals for the third pair of power switching elements based on the neutral leg control reference target; and
driving the third pair of power switching elements in accordance with the control signals for the third pair of power switching elements.

44-70. (canceled)
